(19) United States
(12) Patent Application Publication
(10) Pub. No.: US 2014/0233998 A1
(43) Pub. Date: Aug. 21, 2014

(54) IMAGE FORMING APPARATUS AND PROCESS CARTRIDGE

(71) Applicants: Kazuhiko Watanabe, Tokyo (JP); Takaaki Tawada, Kanagawa (JP); Takatsugu Fujishiro, Tokyo (JP); Hisashi Kikuchi, Kanagawa (JP)

(72) Inventors: Kazuhiko Watanabe, Tokyo (JP); Takaaki Tawada, Kanagawa (JP); Takatsugu Fujishiro, Tokyo (JP); Hisashi Kikuchi, Kanagawa (JP)

(73) Assignee: Ricoh Company, Ltd., Tokyo (JP)

(21) Appl. No.: 14/161,651

(22) Filed: Jan. 22, 2014

(30) Foreign Application Priority Data
Feb. 21, 2013 (JP) 2013-032459

(51) Int. Cl. G03G 21/00

(52) U.S. Cl. CPC G03G 21/0011
USPC 399/350

(57) ABSTRACT

A disclosed image forming apparatus forms a toner image on a surface of a surface moving image bearing body and eventually transfers and fixes the toner image onto a recording medium to form an image on the recording medium and removes, by a cleaning apparatus, an adhered matter which is adhered to the surface of the image bearing body after the transferring. In the image forming apparatus, a glass transition temperature (Tg) of a toner is 40-60° C., and the cleaning apparatus causes a tip ridgeline portion of a blade member to be abutted against the surface of the image bearing body to remove the adhered matter from the surface of the image bearing body, and the tip ridgeline portion of the blade member is made of elastic rubber whose 100% modulus value at 23° C. is at least 6 MPa.

### CROSS-REFERENCE TO RELATED APPLICATIONS

This patent application is based on and claims priority pursuant to 35 U.S.C. §119 to Japanese Patent Application No. 2013-032459, filed on Feb. 21, 2013, in the Japan Patent Office, the entire disclosure of each of which is hereby incorporated by reference herein.

### TECHNICAL FIELD

The present invention relates to image forming apparatuses such as a copying machine, a facsimile machine, a printer, etc., and process cartridges.

### BACKGROUND ART

An image forming apparatus is known which forms an image by finally transferring, onto a recording medium, a toner image formed on a surface of a surface moving image bearing body to fix the transferred toner image and which removes adhered matter on a surface of the image bearing body after the transferring.

As a cleaning apparatus, a cleaning blade technique is used which abuts, against the surface of the image bearing body, a tip ridgeline portion (an edge portion) of a cleaning blade made of elastic rubber to dam toner to remove the dammed toner. As the cleaning blade in the related art, a single-layer blade member made of the elastic rubber of low hardness has been widely used. Moreover, the cleaning blade is also known in which an edge portion which abuts against the image bearing body uses the elastic rubber of high hardness with a 100% modulus value of at least 6 MPa (See Patent documents 1 and 2, for example).

### PATENT DOCUMENTS

Patent document 1: JP2011-197309A
Patent document 2: JP2011-197311A

In recent years, energy saving in the image forming apparatus has become increasingly important due to a rise in environmental consciousness in addition to an increase in reliability and life of the image forming apparatus. As the energy saving, saving energy in a fixing process which consumes the largest amount of energy in the image forming apparatus is becoming an important issue, and development of a low temperature fixing toner as well as development of techniques for saving energy of the fixing apparatus itself are also being carried out actively. With the low temperature fixing toner, it is necessary to turn the toner into rubber or soften the rubber at a lower temperature, and, accordingly, a glass transition temperature of the toner also decreases. For example, a toner whose glass transition temperature (Tg) is between 40 and 60° C. is being developed.

On the other hand, a temperature inside a machine rises when an image forming operation is continued in the image forming apparatus. In a temperature range (10-35° C.) envisaged in a normal office environment, the temperature inside the machine may rise up to at least around the glass transition temperature of the low temperature fixing toner. For example, in a medium-speed machine, the temperature inside the machine may rise up to 60° C., which is around the glass transition temperature of the low temperature fixing toner, and in a high-speed machine, it may rise up to an even higher temperature. Moreover, in the cleaning blade technique, frictional heat is produced due to a sliding frictional force at an abutting portion between the image bearing body and the blade member and an edge portion of the blade member rises to a temperature which is higher than the temperature inside the machine.

FIG. 7, in (a), illustrates an expanded view of the abutting portion between the blade member and a photosensitive body, which is the image bearing body. In the cleaning blade technique, while a blade member 72, which abuts against a surface moving photosensitive body 10, dams the toner to remove the dammed toner, in fact a part of the dammed toner T passes little by little through an edge portion 72C which is deformed by abutting against the photosensitive body 10. When the toner passes through the deformed edge portion 72C, it is pressed against the photosensitive body 10.

If the low temperature fixing toner whose glass transition temperature (Tg) is 40-60° C. is used, when the toner passes through the deformed edge portion 72C, the toner easily turns into rubber or softens to be adhered onto the photosensitive body 10 due to a pressing force and a temperature rise of the edge portion. As shown in (b) in FIG. 7, the toner T1 which is adhered to the photosensitive body 10 takes a film shape T2 over time, causing filming to occur on the photosensitive body 10. When the filming occurs, failures such as image density unevenness, cleaning failure, charging failure, etc., occur.

### DISCLOSURE OF THE INVENTION

In light of the problems as described above, an object of the present invention is to provide an image forming apparatus which makes it possible to suppress filming onto an image bearing body while saving energy.

According to an embodiment of the present invention, an image forming apparatus is provided which forms a toner image on a surface of a surface moving image bearing body and eventually transfers and fixes the toner image onto a recording medium to form an image on the recording medium and removes, by a cleaning apparatus, an adhered matter which is adhered to the surface of the image bearing body after the transferring, wherein a glass transition temperature (Tg) of a toner is 40-60° C., wherein the cleaning apparatus causes a tip ridgeline portion of a blade member to be abutted against the surface of the image bearing body to remove the adhered matter from the surface of the image bearing body, and wherein the tip ridgeline portion of the blade member is made of elastic rubber whose 100% modulus value at 23° C. is at least 6 MPa.

According to the present invention, a blade member whose tip ridgeline portion (an edge portion) is made of elastic rubber having the above-described characteristics is used as a cleaning apparatus to reduce deformation in the edge portion relative to the blade member made of elastic rubber of low hardness to suppress an increase in an abutting area. In this way, an abutting face pressure is increased and damming capabilities by the blade member are improved, making it possible to prevent a portion of the dammed toner from passing by the deformed edge portion. Moreover, the increase in the abutting area is suppressed, so that a sliding frictional force between the image bearing body and the edge portion may be suppressed to suppress generation of frictional heat that would cause a rise in temperature of the edge portion to be suppressed.

Such a blade member may be used to suppress occurrence of filming in which, even when using a toner for low temperature fixing at a glass transition temperature (Tg) of 40-60° C., the toner adheres in a film shape on an image bearing body.

According to the present invention, an image forming apparatus is provided which makes it possible to suppress filming onto an image bearing body while achieving energy saving.

### BRIEF DESCRIPTION OF THE DRAWINGS

Other objects, features, and advantages of the present invention will become more apparent from the following detailed descriptions when read in conjunction with the accompanying drawings, in which:

FIG. 1 is a schematic configuration diagram illustrating a printer according to the present embodiment;

FIG. 2 is a schematic configuration diagram illustrating a process cartridge provided by the printer;

FIG. 3 is a schematic diagram illustrating a schematic configuration of a cleaning blade provided by the printer;

FIG. 4 is an expanded view of an abutting portion between the cleaning blade and a photosensitive body according to the present embodiment;

FIGS. 5A to 5D are explanatory diagrams of a layer configuration of the photosensitive body according to the present embodiment;

FIG. 6 is a schematic configuration diagram illustrating the process cartridge provided by a related-art printer;

FIG. 7 is an expanded view of the abutting portion between the cleaning blade of low hardness and the photosensitive body in the related art.

### BEST MODE FOR CARRYING OUT THE INVENTION

Below, one embodiment in which the present invention is applied to a printer as an image forming apparatus is described.

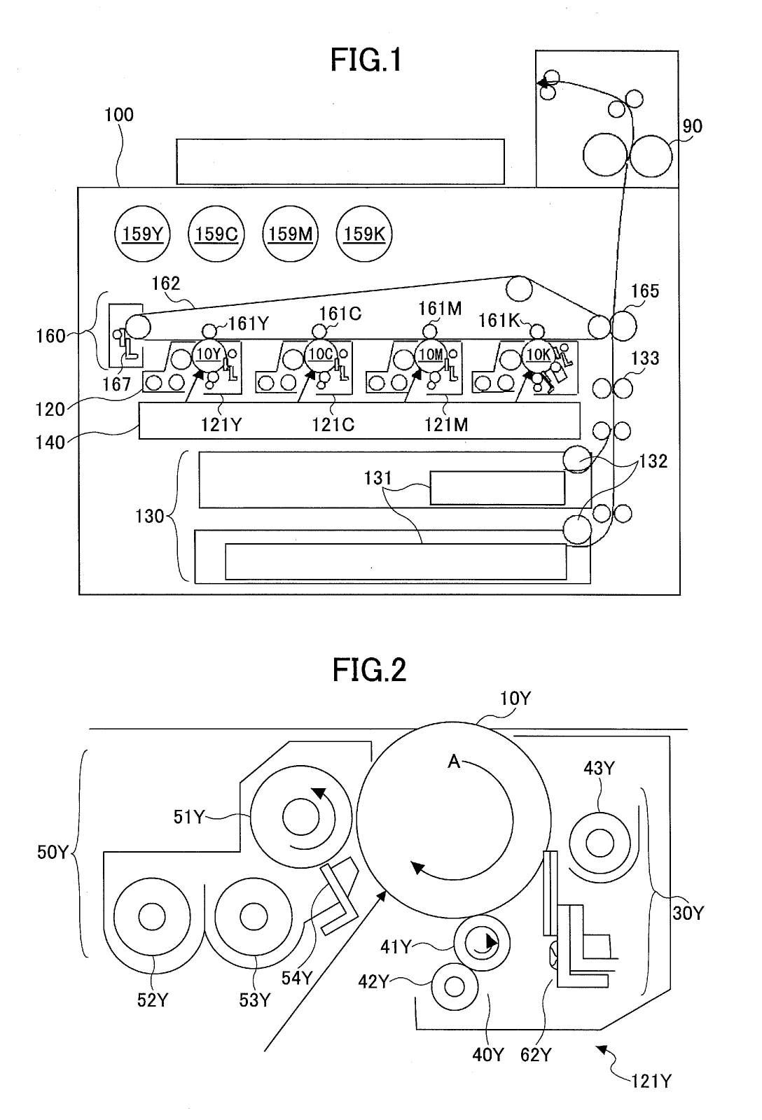

FIG. 1 is a schematic configuration diagram illustrating a printer 100 as an image forming apparatus according to the present embodiment.

The printer 100, which forms a full-color image, mainly includes an image forming apparatus 120, an intermediate transfer apparatus 160, and a paper-feeding unit 130. In the descriptions below, suffixes Y, C, M, and K respectively show that they are members for yellow, cyan, magenta, and black.

In order from the left side shown, the image forming unit 120 includes a process cartridge 121Y for yellow, a process cartridge 121C for cyan, a process cartridge 121M for magenta, and a process cartridge 121K for black. These process cartridges 121Y, 121C, 121M, and 121K are tandem-type printers which are arranged in alignment in a generally horizontal direction.

The intermediate transfer apparatus 160 is configured to mainly include an endless intermediate transfer belt 162 as an intermediate transfer body which is stretched over multiple supporting rollers; primary transfer rollers 161Y, 161C, 161M, 161K; and a secondary transfer roller 165. Above the respective process cartridges 121Y, 121C, 121M, and 121K, the intermediate transfer belt 162 is arranged along a surface moving direction of drum-shaped photosensitive bodies 10Y, 10C, 10M, and 10K as surface moving image bearing bodies provided in the respective process cartridges above. The intermediate transfer belt 162 undergoes surface movement in synchronization with surface movement of the photosensitive bodies 10Y, 10C, 10M, and 10K. Moreover, the respective primary transfer rollers 161Y, 161C, 161M, and 161K are arranged on the inner peripheral face side of the intermediate transfer belt 162. These primary transfer rollers 161Y, 161C, 161M, and 161K cause an outer peripheral face (a surface) located on the lower side of the intermediate transfer belt 162 to be weakly abutted against an outer peripheral face (surface) of the respective photosensitive bodies 10Y, 10C, 10M, and 10K.

The configuration and the operation of forming a toner image on the respective photosensitive bodies 10Y, 10C, 10M, and 10K and transferring the formed toner images onto the intermediate transfer belt 162 is substantially the same for the respective process cartridges 121Y, 121C, 121M, and 121K. Primary transfer rollers 161Y, 161C, and 161M that correspond to three process cartridges 121Y, 121C, and 121M for color are provided with a swing mechanism (not shown) which swings these up and down. The swing mechanism operates such that the intermediate transfer belt 162 is not caused to be in contact with the photosensitive bodies 10Y, 10C, and 10M when a color image is not being formed.

The intermediate transfer apparatus 160 as an intermediate transfer unit is configured to be able to be attached to and detached from a body of the printer 100. More specifically, a front cover (not shown) on the near side of the paper face in FIG. 1 that covers the image forming unit 120 of the printer 100 is opened and the intermediate transfer apparatus 160 is caused to slide to the near side from the far side of the paper face in FIG. 1, making it possible to remove the intermediate transfer apparatus 160 from the body of the printer 100. When the intermediate transfer apparatus 160 is mounted in the body of the printer 100, an operation which is reverse the removal operation may be carried out.

On the upstream side of the process cartridge 121Y, which is on the downstream side in a surface moving direction relative to the secondary transfer roller 165 in the intermediate transfer belt 162, is provided an intermediate transfer belt cleaning apparatus 167. The intermediate transfer belt cleaning apparatus 167 removes adhered matter on the intermediate transfer belt 162 such as residual toner, etc., after a secondary transfer. The intermediate transfer belt cleaning apparatus 167 is configured to be able to be detached from and attached to the body of the printer 100 as the intermediate transfer apparatus 160 while being integrally supported with the intermediate transfer belt 162.

Above the intermediate transfer apparatus 160, toner cartridges 159Y, 159C, 159M, and 159K which correspond to the respective process cartridges 121Y, 121C, 121M, and 121K are arranged in a generally horizontal direction. Moreover, below the process cartridges 121Y, 121C, 121M, and 121K is arranged an exposing apparatus 140 which irradiates laser light on surfaces of the charged photosensitive bodies 10Y, 10C, 10M, and 10K to form an electrostatic latent image. Moreover, below the exposing apparatus 140, the paper-feeding unit 130 is arranged.

In the paper-feeding unit 130, paper-feeding cassettes 131 and paper-feeding rollers 132 that store transfer paper as a recording material are provided; a transfer paper is fed at predetermined timing toward a secondary transfer nip portion between the intermediate transfer belt 162 and the secondary transfer roller 165 via a Registration roller pair 133. Moreover, on the downstream side in the transfer paper conveying direction of the secondary transfer nip portion is arranged a fixing apparatus 90, while, on the downstream side in the transfer paper conveying direction of this fixing apparatus 90 is arranged a paper-discharging storage unit which stores a transfer sheet discharged and a paper-discharging roller.

FIG. 2 is a schematic configuration diagram illustrating a process cartridge 121 included in the printer 100.

Here, configurations of the respective process cartridges 121 are almost the same, so that configurations and operations of the process cartridge 121 are described, omitting suffixes Y, C, M, and K for different colors in the descriptions below.

The process cartridge 121 includes a developing apparatus 50, a charging apparatus 40, and a cleaning apparatus 30 which is arranged around the photosensitive body 10; and the photosensitive body 10.

The charging apparatus 40 mainly includes a charging roller 41 arranged to abut against the photosensitive body 10; and a charging roller cleaner 42 which abuts against this charging roller 41 to rotate. In the charging roller 41, a conductive rubber layer is provided on a core bar. A voltage is which alternating current is superposed on direct current is applied to the charging roller 41. The alternating current is superposed on the direct current to obtain a superior charging uniformity and superior charging performance. Taking into account staining, the charging roller 41 may be arranged in a manner such that it opposes the photosensitive body 10 with a minute gap. In this case, it becomes more difficult for the toner, etc., from the surface of the photosensitive body 10 to adhere to the charging roller 41, so that staining of the charging roller 41 is suppressed, achieving an increased service life.

The developing apparatus 50 includes a developing roller 51 as a developing agent bearing body. A developing bias is to be applied to this developing roller 51 from a power supply (not shown). Within a casing of the developing apparatus 50 is provided an agitating screw 53 and a supplying screw 52 that agitate a developing agent stored within the casing while mutually conveying it in reverse directions. Moreover, a doctor 54 is also provided for regulating the developing agent borne by the developing roller 51. The toner in the developing agent agitated and conveyed by two screws of the agitating screw 53 and the supplying screw 52 is charged to a predetermined polarity. Then, the developing agent is drawn onto the surface of the developing roller 51 and the drawn developing agent is regulated by the doctor 54 and the toner adheres to a latent image on the photosensitive body 10 in a developing region which opposes the photosensitive body 10.

The cleaning apparatus 30 includes a cleaning blade 62, a collecting screw 43, etc. The cleaning blade 62 abuts against the photosensitive body 10 in a direction counter to a surface moving direction of the photosensitive body 10. The toner which remains on the photosensitive body 10 after transferring the toner image onto the intermediate transfer belt 162 is removed by the cleaning blade 62. The toner removed by the cleaning blade 62 is conveyed to a waste toner container (not shown) by the collecting screw 43. Details of the cleaning blade 62 are described below.

The respective ones of four process cartridges 121 having the above-described configuration can be detached/attached or replaced one by one by a servicing person or a user. Moreover, the process cartridge 121, which is removed from the printer 100, is configured to make it possible to replace the photosensitive body 10, the charging apparatus 40, the developing apparatus 50, and the cleaning apparatus 30 by new apparatuses. The process cartridge 121 may include a waste toner tank into which is collected a post-transfer residual toner which is collected by the cleaning apparatus 30. In this case, convenience is improved if the waste toner tank is configured to be able to be detached/attached or replaced.

Next, an operation of the printer 100 is described.

The printer 100, upon accepting a print instruction from an external equipment unit (not shown), first causes the photosensitive body 10 to rotate in an arrow A direction in FIG. 2, and uniformly charges a surface of the photosensitive body 10 to a predetermined polarity by the charging roller 41 of the charging apparatus 40. The exposing apparatus 140 irradiates laser beam lights, for example, for the respective colors that are optically modulated in correspondence with input color image data and thereby forms electrostatic latent images of the respective colors on the surfaces of the respective photosensitive bodies 10. To the respective electrostatic latent images, developing agents of various colors are supplied from the developing rollers 51 of the developing apparatuses 50 of the respective colors, the electrostatic latent images of the respective colors are developed in the developing agents of the respective colors, and toner images corresponding to the respective colors are formed to visualize the toner images. Next, a transfer voltage of a polarity opposite that of the toner image is applied to each of the primary transfer rollers 161 to form a primary transfer electric field between the photosensitive body 10 and each of the primary transfer rollers 161 via the intermediate transfer belt 162. The intermediate transfer belt 162 is brought into weak abutment with each of the primary transfer rollers 161 to form a primary transfer nip. With these actions, the toner images on the respective photosensitive bodies 10 are efficiently primarily transferred onto the intermediate transfer belt 162. On the intermediate transfer belt 612, the toner images of the respective colors that are formed on the respective photosensitive bodies 10 are transferred such that they are mutually superposed, and a laminated toner image is formed.

As for the laminated toner image which is primarily transferred onto the intermediate transfer belt 162, a transfer paper stored in the paper-feeding cassette 131 is fed at predetermined timing via the paper-feeding roller 132, the Registration roller pair 133, etc. Then, a transfer voltage with a polarity opposite that of the toner image is applied to the secondary transfer roller 165, so that a secondary transfer electric field is formed between the intermediate transfer belt 162 and the secondary transfer roller 165 and a laminated toner image is transferred onto the transfer paper. The transfer paper onto which the laminated toner image is transferred is sent to the fixing apparatus 90, and fixed by heat and pressure. The transfer sheet onto which the toner image is fixed is discharged and placed onto a discharged paper storing unit by a paper-discharging roller. On the other hand, the post-transfer residual toner which remains on the respective photosensitive bodies 10 after the primary transfer is scrapped off and removed by the cleaning blades 62 of the respective cleaning apparatuses 30.

Next, elements of the printer 100 are described.

In the printer 100, a low temperature fixing toner such that a glass transition temperature (Tg) is 40-60° C. as a toner which forms a toner image is used to achieve energy saving in a fixing process. Moreover, the photosensitive body 10 includes a surface layer containing fine particles. The low temperature fixing toner and the photosensitive body 10 are described in detail later.

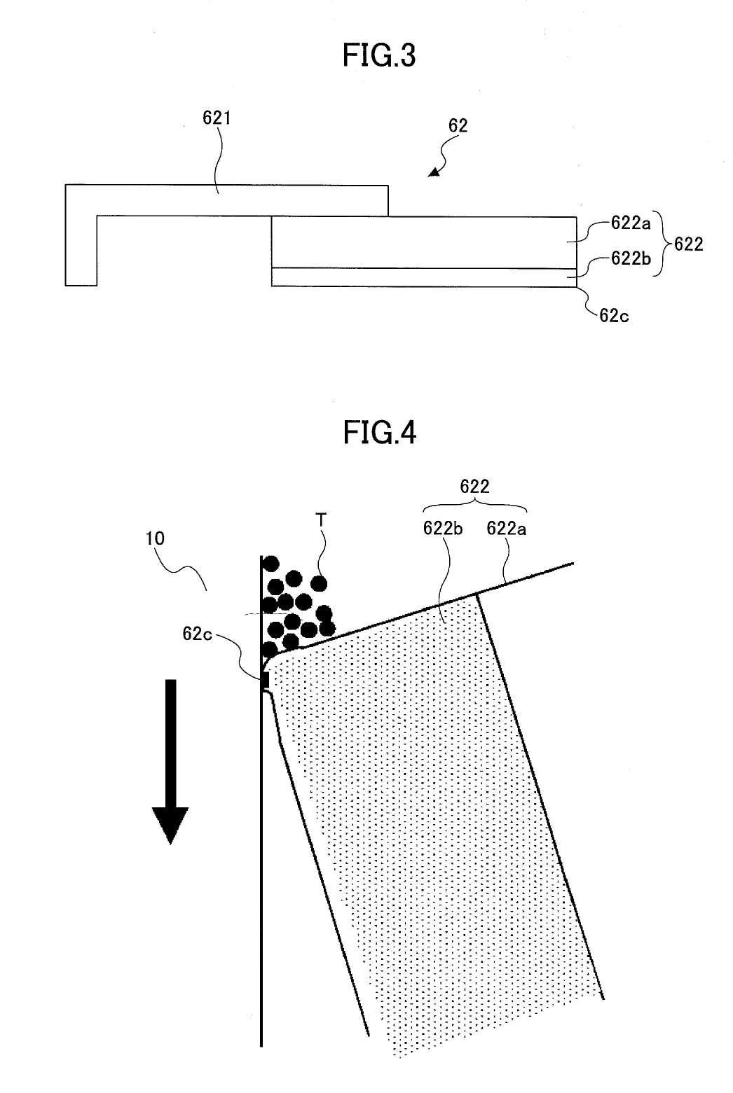

Moreover, in the printer 100, the following cleaning blade 62 is used. FIG. 3 is a schematic diagram illustrating a schematic configuration of the cleaning blade 62.

The cleaning blade 62 is configured to include a thin rectangular-shaped elastic blade 622 and a thin rectangular-shaped holder 621 including a rigid material such as metal, hard plastic, etc. The elastic blade 622 is fixed to a first end side of the holder 621 by an adhesive, etc., and another end side of the holder 621 is cantilever-supported by a casing of the cleaning apparatus 30.

As shown in FIG. 4, the elastic blade 622 is a laminated blade which is configured to include two layers of an edge layer 622b and a backup layer 622a. The edge layer 622b is a layer which forms a tip ridgeline portion 62c which is in direct contact with the photosensitive body 10. The edge layer 622b uses a urethane rubber material with a strength which is higher than that of the backup layer 622a. A combination is formed such that a 100% modulus value of the edge layer 622b is larger than that of the backup layer 622a. As one example of the combination of the edge layer 622b and the backup layer 622a, a urethane rubber material with the 100% modulus (at 23° C.) of 6-7 MPa is used as the edge layer 622b, and a urethane rubber material with that of 4-5 MPa is used as the backup layer 622a. As the edge layer 622b, one with the 100% modulus (at 23° C.) in a range of between 6 MPa and 12 MPa may be used suitably. Moreover, in rubber hardness, an urethane rubber of 80 degrees (JIS A) is used for the edge layer 622b and an urethane rubber of 75 degrees (JIS A) is used for the backup layer 622a. A thickness of the edge layer 622b is set to be 0.5 mm, while a thickness of the backup layer 622a is set to be 1.3 mm.

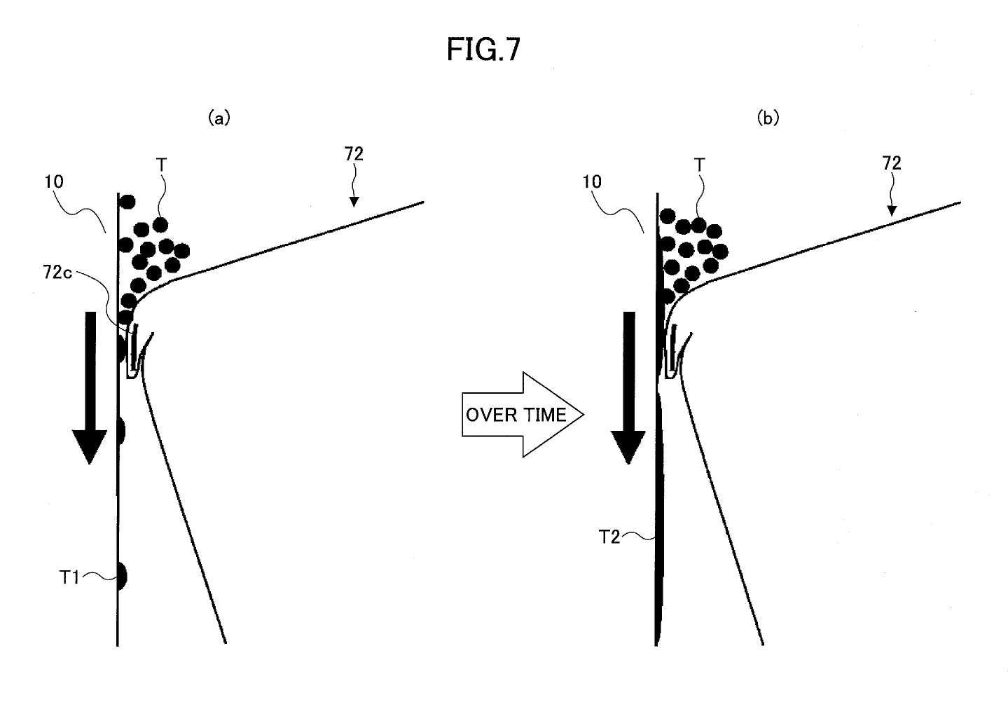

FIG. 6 is a diagram illustrating a process cartridge 222 which adopts a cleaning blade 72 using a related art single-layer elastic blade, while FIG. 7, in (a), shows an expanded view of an abutting portion between the photoconductive body 10 and the cleaning blade 72 in FIG. 6. The cleaning blade 72 uses a urethane rubber material of around 72 degrees in hardness and a 100% modulus (at 23° C.) of 4.6 MPa. In such a related art single-layer cleaning blade 72, it is unlikely for loss of elasticity to occur even when it continues to be abutted against the photosensitive body 10 over a long time, so that an initial state of abutting may be maintained. However, as hardness is lower, deforming in the edge portion which abuts against the photosensitive body 10 increases and an abutting area increases, so that the abutting pressure decreases. Therefore, due to a wedge effect, the dammed toner passes through, little by little, the edge portion deformed by a part thereof being abutted against the photosensitive body 10. When the toner passes through the deformed edge portion, it is pressed against the photosensitive body 10.

Moreover, due to a continued image forming operation in the printer 100, the temperature inside the machine may rise to at least around the glass transition point temperature of the low temperature fixing toner. For example, in a medium speed machine with a line speed of approximately 140-260 mm/s, the temperature inside the machine may rise to 60° C., which is around the glass transition temperature of the low temperature fixing toner. In a high-speed machine whose line speed is approximately 350-650 mm/s, the temperature inside the machine may increase to an even high temperature. Moreover, frictional heat due to a sliding frictional force is produced in an abutting portion between the photosensitive body 10 and the cleaning blade 72 and the temperature of an edge portion of the cleaning blade 72 rises to a temperature higher than the temperature inside the machine.

When the low temperature fixing toner whose glass transition temperature (Tg) is 40-60° C. passes through the deformed edge portion, the toner easily turns into rubber or softens to be adhered onto the photosensitive body 10 due to a pressing force and a temperature rise of the edge unit. As shown in FIG. 7 in (b), the toner which is adhered to the photosensitive body 10 takes a film shape over time, causing filming to occur on the image bearing body. The occurrence of the filming causes failures such as image density unevenness, cleaning failure, charging failure, etc., to occur.

FIG. 4 is an expanded view of an abutting portion between the cleaning blade 62 and the photosensitive body according to the present embodiment.

In the cleaning blade 62 according to the present embodiment, an effect of the edge layer 622b which includes high strength materials causes the strength of the tip ridgeline portion 62C to increase. Therefore, deformation in the edge portion is reduced in comparison to the cleaning blade 72 including low hardness elastic rubber as shown in FIG. 7, suppressing the abutting area to increase. In this way, an abutting face pressure is increased and damming capabilities by the cleaning blade 62 are improved, making it possible for a portion of the dammed toner to be prevented from passing by the deformed edge portion. Moreover, an increase of the abutting area is suppressed, so that a sliding frictional force between the photosensitive body 10 and the edge portion may be suppressed to suppress generation of frictional heat, causing a rise in temperature of the edge portion to be suppressed. Filming into a film shape may be suppressed by a pressing force and a temperature rise of the edge portion.

Moreover, the printer 100 includes a surface layer containing fine particles of the photosensitive body 10, so that concave-convexity due to the fine particles is formed on the surface of the photosensitive body 10. With this photosensitive body 10, a contact area between the edge portion and the photosensitive body 10 is reduced relative to the photosensitive body whose surface is smooth and which does not contain the fine particles. Therefore, sliding frictional force between the photosensitive body 10 and the edge portion may decrease to suppress occurrence of frictional heat, so that a temperature increase in the edge portion is suppressed. Moreover, in a concave portion formed on a surface of the photosensitive body 10, a pressing force by the cleaning blade 62 is reduced, making it difficult for the toner to be adhered to the concave portion. Therefore, the toner taking a film-shape on the photosensitive body 10 over time is suppressed.

Such cleaning blade 62 and photosensitive body 10 may be used to suppress occurrence of filming in which, even when using a low temperature fixing toner at a glass transition temperature (Tg) of 40-60° C. for saving energy, the toner adheres in a film shape on the photosensitive body.

Moreover, the photosensitive body 10 preferably has a Martens hardness (HM) of a surface layer of at least 190 N/mm² and an elasticity work rate (We/Wt) of at least 37.0%. Setting the Martens hardness (HM) to be at least 190N/mm² causes filming of toner and toner additive particles onto the surface of the photosensitive body 10 to be difficult. Moreover, when the elastic work rate (We/Wt) is less than 37.0%, abrasion unevenness and changes in the photosensitive body abrasion speed are likely to occur in a photosensitive body axial direction when an image area is changed. At a location with much abrasion, the concavity-convexity due to the surface layer is lost, causing a likelihood of occurrence of filming of the toner and toner additive agent particles to increase.

Moreover, the elastic blade 622 as described above is arranged to have a laminated layer structure in which a material with a 100% modulus value which is smaller than that of an edge layer 622b which abuts against the photosensitive body 10 is used, while setting the edge layer 622b to be of high hardness to prevent filming. This is because, while enlarging of the nip is suppressed when a high strength material of high hardness is used as a monolayer as in a related art cleaning blade, a long term use may cause a loss of elasticity, causing a decrease in abutting pressure, so that a decrease in cleaning performance may occur. Setting the elastic blade 622 with a dual layer laminated structure and using a material with a 100% modulus value and a strength which are lower than those of the edge layer 622b cause the loss of the elasticity due to long term use and the decrease in the abutting pressure to be prevented. This makes it possible to further maintain the decreasing effect of the filming and superior cleaning performance over a long time. This causes an increased reliability and service life to be achieved.

Moreover, at the time of using the low temperature fixing toner, in order to prevent an abnormal image due to filming onto the photosensitive body 10 of the toner, it is effective to decrease the repulsion elasticity of the edge layer 622b which abuts against the photosensitive body 10. However, decreasing the repulsion elasticity causes the cleaning performance under a low temperature environment to decrease. Therefore, in the elastic blade 622 according to the present embodiment, the relative magnitude relationship of the repulsion elasticity of the edge layer 622b and the repulsion elasticity of the backup layer 622a preferably meets the relationship that the repulsion elasticity of the edge layer<the repulsion elasticity of the backup layer at least at 10° C. The repulsion elasticity of the backup layer 622a is set to be larger than the repulsion elasticity of the edge layer 622b to normalize the repulsion elasticity in the overall laminated elastic blade 622. This makes it possible to maintain the cleaning performance under the low temperature environment while preventing the filming.

Moreover, at the time of using the low temperature fixing toner, in order to prevent an abnormal image due to the filming onto the photosensitive body 10 of the toner, it is effective to increase the tan δ peak temperature of the edge layer 622b which abuts against the photosensitive body 10. This makes it possible to reduce rubber properties under the low temperature environment and stick-slip movement of the elastic blade 622. However, increasing the tan δ peak temperature causes the cleaning performance under the low temperature environment to decrease. Therefore, in the elastic blade 622 of the present embodiment, the relative magnitude relationship of the tan δ peak temperature of the edge layer 622b and the tan δ peak temperature of the backup layer 622a preferably meets the relationship that the tan δ peak temperature of the edge layer>the tan δ peak temperature of the backup layer. The tan δ peak temperature of the backup layer 622a is decreased to enhance the rubber properties of the backup layer 622a and normalize the tan δ peak temperature in the overall laminated elastic blade 622. This makes it possible to maintain the cleaning performance under the low temperature environment while preventing the filming.

Examples 1-3 of the cleaning blade 62 adopted in the present printer 100 are more specifically described as listed items in Table 1.

TABLE 1

| | | EXAMPLE 1 | | EXAMPLE 2 | | EXAMPLE 3 | |
|---|---|---|---|---|---|---|---|
| | | EDGE | BACKUP | EDGE | BACKUP | EDGE | BACKUP |
| ITEM | | LAYER | LAYER | LAYER | LAYER | LAYER | LAYER |
| HARDNESS | | 80 | 73 | 79 | 73 | 80 | 64 |
| 100% MODULUS (Mpa) | | 6 | 4 | 6 | 4 | 6 | 2.5 |
| REPULSION | 10° C. | 13 | 25 | 14 | 25 | 13 | 7 |
| ELASTICITY (%) | 23° C. | 23 | 34 | 16 | 34 | 23 | 12 |

| | | | | | | |
|---|---|---|---|---|---|---|
| PERMANENT | 1.9 | 0.6 | 1.6 | 0.6 | 1.9 | 0.09 |
| ELONGATION (%) | | | | | | |
| tan δ PEAK | 5 | −8 | 15 | −8 | 5 | 9 |
| TEMPERATURE (° C.) | | | | | | |

In the cleaning blade 62 according to Examples 1-3, the edge layer 622b uses a rubber material with a 100% modulus (at 23° C.) of 6 MPa, thereby decreasing deformation in the edge portion to prevent the filming. Moreover, as the backup layer 622a, a rubber material with the hardness which is lower than that of the edge layer 622b may be used to prevent a loss of elasticity due to a long-term use and a decrease in abutting pressure. This makes it possible to maintain the decreasing effect of the filming and superior cleaning performance over a longer time.

In the cleaning blade 62 according to Example 2, the repulsion elasticity of the edge layer 622b is lowered relative to Example 1 to suppress the stick-slip phenomenon of the edge portion to stabilize the behavior of the edge, thereby achieving a further decreasing effect in filming and cleaning performance.

In the cleaning blade 62 according to Example 3, the 100% modulus of the backup layer 622a is further decreased relative to Example 1 to decrease the pressure of contact against the photosensitive body of the elastic blade 622 to suppress the photosensitive body film abrasion, thereby achieving an increased service life of the photosensitive body.

Moreover, in the cleaning blade 62 according to Example 1 or 2, the repulsion elasticity of the backup layer 622a at 10° C. is set to be larger than the repulsion elasticity of the edge layer 622b to normalize the repulsion elasticity in the overall laminated elastic blade 622. Moreover, the tan δ peak temperature of the backup layer 622a is set to be lower than the tan δ peak temperature of the edge layer 622b to normalize the tan δ peak temperature in the overall laminated elastic blade 622. This makes it possible to maintain the cleaning performance under the low temperature environment while preventing the filming.

Next, using the low temperature fixing toner, the experiments are described which compare and study the presence of filming occurrence between the cleaning blade 62 adopted in the present printer 100 and a related-art cleaning blade.

As the low temperature fixing toner used in the experiments, two types of low temperature fixing toner, which are the toner with the glass transition temperature (Tg) of 45° C. and the toner with the glass transition temperature (Tg) of 59° C., were used. Moreover, in order to efficiently compare the filming occurrence conditions in a relatively short time, the experiments were carried out under the following conditions such that the filming would likely occur based on the knowledge to date of the present inventors, etc.

### (Experimental Conditions)

Image outputting with 10,000 sheets was successively carried out within about 2 hours in an environment of 32° C. and 54% in which the temperature inside the machine is likely to rise. In order to maximize the toner input into the photosensitive body 10, an image whose whole face is solid is output on an AA4 recording paper. As an experimental machine, an MPC5000 machine manufactured by Ricoh is used. In this experimental machine, the image outputting was carried out by changing the charging technique by the charging roller 41, the photosensitive body 10, and the cleaning blade 62 of the process cartridge having a configuration shown in FIG. 2 to the respective conditions in Experiments 1-8 in Table 2.

A “high strength edge blade”, which is the cleaning blade 62 shown in Table 2, is a laminated blade according to Example 2 shown in Table 1. On the other hand, a “low strength edge blade”, which is the cleaning blade as a comparative example, is a single-layer blade having the following properties which are widely used in the related art:

Edge hardness: 74 degrees

100% modulus: 4.6 MPa

Repulsion elasticity: 11.7% (10° C.), 19.8% (23° C.)

Permanent elongation: 1.32%

Tan δ peak temperature: 8° C.

Moreover, investigations were carried out using two types of photosensitive bodies 10 in the experiments. Here, the term “with fine particles” for the photosensitive body 10 shown in Table 2 indicates a photosensitive body having a surface layer containing the below-described fine particles. On the other hand, the term “without fine particles” indicates a photosensitive body having a surface layer not containing the fine particles.

Moreover, in the experiments, investigations were carried out using two types of charging techniques of contact DC charging and non-contact AC charging. From the knowledge to date of the present inventors, etc., it has been demonstrated that the filming onto the photosensitive body 10 of the toner is more likely to occur in the AC charging than in the DC charging, so that evaluations in the AC charging as acceleration conditions for the DC charging are carried out.

Under the respective conditions shown for Experiments 1-8 in Table 2, filming of the photosensitive body surface is visually inspected while carrying out image outputting and presence/absence of an abnormal image (a solid black with white microdots) in a solid image is checked and ranking was carried out.

### (Ranking Criteria)

Rank 5: the filming is not observed with visual inspection, and no abnormal image is seen even in the solid image.

Rank 4: the filming is slightly observed with the visual inspection, and the solid black with the white microdots is slightly seen even in the solid image; however, there is no problem in actual use.

Rank 3: the filming is observed with the visual inspection, the solid black with the white microdots is seen even in the solid image, which may be problematic in actual use.

Rank 2: the filming is observed with the visual inspection, the solid black with the white microdots is clearly seen even in the solid image, which would be problematic in actual use.

Rank 1: the filming is observed in a large number with the visual inspection, the solid black with the white microdots is clearly seen even in the solid image, which would be problematic in actual use.

TABLE 2

| | | | | FILMING RANK | | | |
|---|---|---|---|---|---|---|---|
| | | | | TONER Tg 45° C. | | TONER Tg 59° C. | |
| | | PHOTO- | | AFTER | AFTER | AFTER | AFTER |
| EXPERIMENT | CLEANING | SENSITIVE | CHARGING | 5000 | 10000 | 5000 | 10000 |
| No | BLADE | BODY | METHOD | SHEETS | SHEETS | SHEETS | SHEETS |
| 1 | LOW STRENGTH | WITHOUT FINE | CONTACT DC | 3 | 1 | 4 | 3 |
| | EDGE BLADE | PARTICLES | CHARGING | | | | |
| 2 | LOW STRENGTH | WITH FINE | CONTACT DC | 3 | 2 | 4 | 4 |
| | EDGE BLADE | PARTICLES | CHARGING | | | | |
| 3 | HIGH STRENGTH | WITHOUT FINE | CONTACT DC | 5 | 4 | 5 | 5 |
| | EDGE BLADE | PARTICLES | CHARGING | | | | |
| 4 | HIGH STRENGTH | WITH FINE | CONTACT DC | 5 | 5 | 5 | 5 |
| | EDGE BLADE | PARTICLES | CHARGING | | | | |
| 5 | LOW STRENGTH | WITHOUT FINE | NON-CONTACT | 1 | 1 | 3 | 1 |
| | EDGE BLADE | PARTICLES | AC CHARGING | | | | |
| 6 | LOW STRENGTH | WITH FINE | NON-CONTACT | 2 | 1 | 3 | 2 |
| | EDGE BLADE | PARTICLES | AC CHARGING | | | | |
| 7 | HIGH STRENGTH | WITHOUT FINE | NON-CONTACT | 4 | 4 | 5 | 5 |
| | EDGE BLADE | PARTICLES | AC CHARGING | | | | |
| 8 | HIGH STRENGTH | WITH FINE | NON-CONTACT | 5 | 4 | 5 | 5 |
| | EDGE BLADE | PARTICLES | AC CHARGING | | | | |

As shown in Table 2, when using the “high strength edge blade” with the 100% modulus value of at least 6 MPa for the edge layer as the cleaning blade 62, the filming occurrence is suppressed relative to the “low strength edge blade”. Moreover, it is seen that the filming occurrence is suppressed by the photosensitive body 10 containing the fine particles on the surface thereof.

Next, the photosensitive body 10 for use in the printer 100 is described in detail.

The photosensitive body 10 according to the present embodiment includes at least a photosensitive layer on a conductive supporting body and a surface layer of the photosensitive body is such that inorganic fine particles are dispersed in a resin, and, as needed, other layers, etc., are arbitrarily combined.

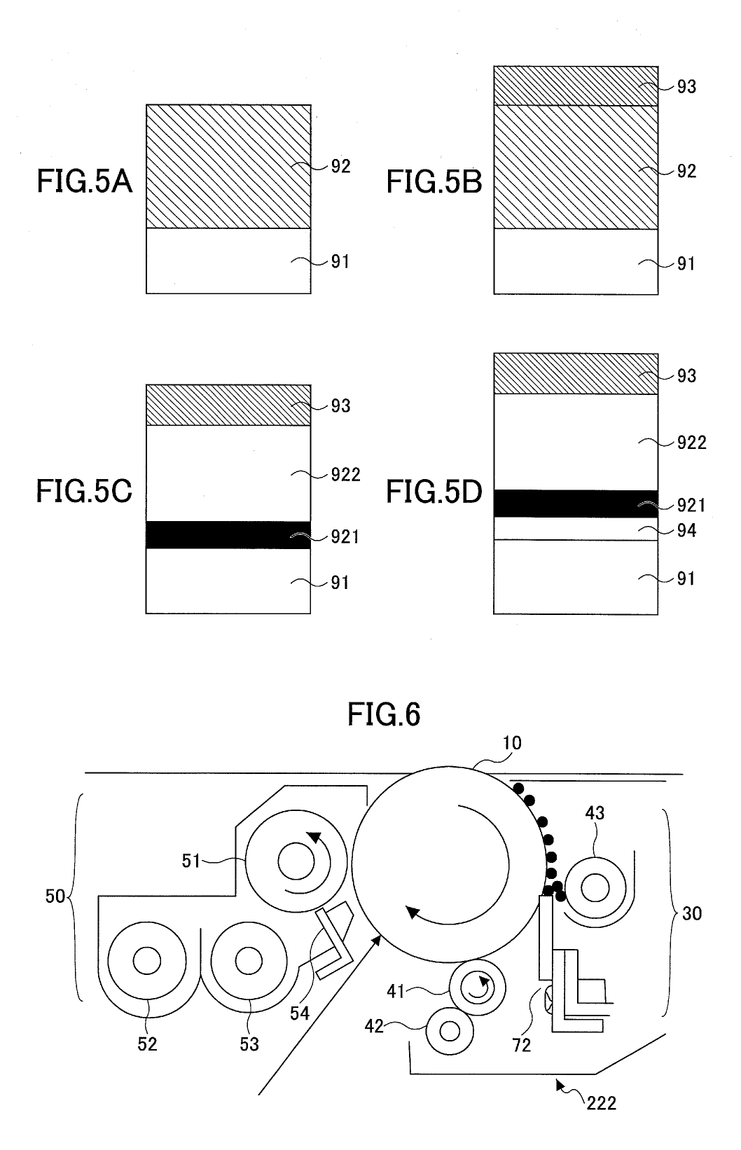

First, a layer structure of the photosensitive body 10 is described using FIGS. 5A to 5D.

FIG. 5A is one example in which a photosensitive layer 92 containing inorganic fine particles is provided near the surface thereof on a conductive supporting body 91. FIG. 5B is one example in which a surface layer 93 containing inorganic fine particles and the photosensitive layer 92 are provided on the conductive supporting body 91. FIG. 5C is one example in which the surface layer 93 containing the inorganic fine particles and the photosensitive layer 92 in which a charge generating layer 921 and a charge transporting layer 922 are laminated are provided on the conductive supporting body 91. FIG. 5D is one example in which the surface layer 93 containing the inorganic fine particles and the photosensitive layer 92 in which the charge generating layer 921 and the charge transporting layer 922 are laminated are provided and an undercoat layer 94 is provided on the conductive supporting body 91.

For the conductive supporting body 91, one indicating conductivity with a volume resistance of less than or equal to 10¹⁰ Ω·cm may be used. For example, a metal such as aluminum, nickel, chrome, Nichrome, copper, gold, silver, platinum, etc.; or a metal oxide such as tin oxide, indium oxide, etc., which is coated onto a film-shaped or cylindrically-shaped plastic or paper by vapor deposition or sputtering may be used. Alternatively, a plate of aluminum, aluminum alloy, nickel, stainless steel, etc., and a pipe which is surface treated by cutting, superfinishing, abrasion, etc., after forming a bare pipe in a process such as extrusion, drawing, etc., may be used. Moreover, an endless belt (an endless nickel belt, an endless stainless belt, etc.) which is disclosed in JPS52-36016A may also be used as the conductive supporting body 91.

On the other hand, conductive powder dispersed in an appropriate binder resin to paint the dispersed conductive powder on the above-described supporting body may also be used as the conductive supporting body 91 of the present invention. The conductive powder includes powder of metal such as carbon black, acetylene black, aluminum, nickel, iron, Nichrome, copper, zinc, silver, etc.; and powder of metal oxide such as conductive tin oxide, ITO, etc. Moreover, the binder resin to be used at the same time includes thermoplastic resin, thermosetting resin, or light curable resin such as polystyrene, styrene-acrylonitrile copolymer, styrene-butadiene copolymer, styrene-maleic anhydride copolymer, polyester, polyvinyl chloride, vinyl chloride-vinyl acetate copolymer, polyvinyl acetate, polyvinylidene chloride, polyarylate resin, phenoxy resin, polycarbonate, cellulose acetate resin, ethyl cellulose resin, polyvinyl butyral, polyvinyl formal, polyvinyl toluene, poly-N-vinyl carbazole, acrylic resin, silicone resin, epoxy resin, melamine resin, urethane resin, phenolic resin, alkyd resin, etc.

Such a conductive layer may be provided by dispersing these conductive powders and binder resin in an appropriate solvent such as tetrahydrofuran, dichloromethane, methyl ethyl ketone, toluene, etc., to coat the dispersed material.

Moreover, a conductive layer which is provided using a thermal shrinkage tube containing the above-described conductive powder in a material such as polyvinyl chloride, polypropylene, polyester, polystyrene, polyvinylidene chloride, polyethylene, chlorinated rubber, Teflon (a registered trademark), etc., on an appropriate cylindrical base body may also be suitably used as the conductive supporting body 91 of the present invention.

Next, the photosensitive layer 92 is described.

The photosensitive layer 92 may be a monolayer or a laminated layer; for convenience of explanations, first a case is described in which it includes a charge generating layer 921 and a charge transporting layer.

The charge generating layer 921 is a layer which has a charge generating material as a main component. For the charge generating layer 921, known charge generating materials can be used; representatives thereof are used which include monoazo pigments, disazo pigments, trisazo pigments, perylene pigments, perinone pigments, quinacridone pigments, quinone condensed polycyclic compounds, squaric acid dyes, other phthalocyanine pigments, naphthalocyanine pigments, azuleneum salt dyes, etc.

In particular, azo pigments and/or phthalocyanine pigments are effectively used. Moreover, in particular, titanyl phthalocyanine having a maximum diffraction peak of at least 27.2° C. may be used effectively as a diffraction peak (±0.2°) of a Bragg angle 2θ for a characteristic X ray (wavelength 1.514 Å) of CuKα.

The charge generating layer 921 is formed by conducting dispersion using a ball mill, attritor, a sand mill, ultrasonic waves, etc., in an appropriate solvent with a binder resin as needed, coating the dispersed material onto the conductive supporting body 91, and drying the coated material.

Examples of the binder resin for use in the charge generating layer 921 as needed include polyamide, polyurethane, epoxy resin, polyketone, polycarbonate, silicone resin, acrylic resin, polyvinyl butyral, polyvinyl formal, polyvinyl ketone, polystyrene, polysulfone, poly-N-vinyl carbazole, polyacrylamide, polyvinyl benzal, polyester, phenoxy resin, chlorovinyl-vinyl acetate copolymer, polyvinyl acetate, polyphenylene oxide, polyamide, polyvinyl pyridine, cellulose resins, casein, polyvinyl alcohol, polyvinylpyrrolidone, etc.

As the quantity of binder resin, 0-500 weight parts, preferably 10-30 weight parts, relative to 100 weight parts of the charge generating material is suitable.

Solvents used here include isopropanol, acetone, methyl ethyl ketone, cyclohexanone, tetrahydrofuran, dioxane, ethyl cellosolve, ethyl acetate, methyl acetate, dichloromethane, dichloroethane, monochlorobenzene, cyclohexane, toluene, xylene, ligroin, etc. In particular, ketone solvents, ester solvents, and ether solvents are preferably used.

As methods of coating a coating liquid, dip coating, spray coating, nozzle coating, beat coating, spinner coating, ring coating, etc., may be used.

For the film thickness of the charge generating layer 921, approximately 0.01-5 μm is suitable; and it is preferably 0.1-2 μm.

The charge transporting layer 922 may be formed by dissolving or dispersing a charge transport material and the binder resin and coating them on the charge generating layer 921 and drying. Moreover, as needed, a plasticizer, a labeling agent, an oxidation inhibitor, etc., may also be added. The charge transporting materials include an electron transporting material and a hole transporting material.

Examples of the electron transport material include electroreceptive materials such as chloranil, bromanil tetracyanoethylene, tetracyano quinodimethane, 2,4,7-trinitro-9-fluorenone, 2,4,5,7-tetranitro-9-fluorenone, 2,4,5,7-tetranitroxanthone, 2,4,8-tetranitrothioxanthone, 2,6,8-trinitro-4H-indino[1,2-b]thiophene-4-on, 1,3,7-trinitro-dibenzothiophene-5,5-dioxide, a benzoquinone derivative, etc.

Examples of the hole transport material include known materials such as poly-N-vinylcarbazole and a derivative thereof; poly-γ-carbazolyl ethylglutamate and a derivative thereof, pyrene-formaldehyde condensate and a derivative thereof, polyvinyl pyrene, polyvinyl phenanthrene, polysilane, an oxazole derivative, an oxydiazole derivative, an imidazole derivative, a monoaryl amine derivative, a diaryl amine derivative, a triaryl amine derivative, a stilbene derivative, an α-phenyl stilbene derivative, a benzidine derivative, a diarylmethane derivative, a triarylmethane derivative, a 9-styrylantracene derivative, a pyrazoline derivative, a divinylbenzene derivative, a hydrazone derivative, an indene derivative, a butadiene derivative, a pyrene derivative, a bisstilbene derivative, an enamine derivative, etc.

These charge transporting materials may be used alone, or as a combination of at least two types thereof.

Moreover, examples of the binder resin include thermoplastic resin or thermosetting resin such as polystyrene, styrene-acrylonitrile copolymer, styrene-butadiene copolymer, styrene-maleic anhydride copolymer, polyester, polyvinyl chloride, vinyl chloride-vinyl acetate copolymer, polyvinyl acetate, polyvinylidene chloride, PAR, phenoxy resin, polycarbonate, cellulose acetate resin, ethyl cellulose resin, polyvinyl butyral, polyvinyl formal, polyvinyl toluene, poly-N-vinyl carbazole, acrylic resin, silicone resin, epoxy resin, melamine resin, urethane resin, phenolic resin, alkyd resin, etc.

The quantity of the charge transporting material is suitably 20-300 weight parts, preferably 40-150 weight parts relative to 100 weight parts of binder resin.

Moreover, in terms of resolution and responsiveness, the film thickness of the charge transporting layer 922 is preferably set to be less than or equal to 25 μm. While a lower limit value varies with a system used (a charging potential, etc.), for example, at least 5 μm is preferable.

Solvents used here include tetrahydrofuran, dioxane, toluene, dichloromethane, monochlorobenzene, dichloroethane, cyclohexanone, methyl ethyl ketone, acetone, etc.

In the photosensitive body 10 according to the present embodiment, a plasticizer or a labeling agent may be added into the charge transport layer 922.

As the plasticizer, what are used as a common resin plasticizer, such as dibutylphthalate, dioctylphthalate, etc., may be used as they are, and approximately 0-30 wt % relative to the binder resin is suitable for the quantity of use thereof.

As the labeling agent, silicone oils such as dimethyl silicon oil, methyl phenyl silicon oil, etc., and an oligomer or a polymer having a perfluoroalkyl group in a side chain are used, the quantity of which usage is suitably 0-1 wt % relative to the binder resin.

When the charge transporting layer 922 is a surfacemost layer, inorganic fine particles are contained in the charge transporting layer 922. Examples of the inorganic fine particles include powder of metals such as copper, tin, aluminum, indium, etc.; metal oxides such as silicon oxide, silica, tin oxide, zinc oxide, titanium oxide, indium oxide, antimony oxide, bismuth oxide, antimony-doped tin oxide, and tin-doped indium oxide; inorganic material such as titanic acid potassium, etc. In particular, the metal oxides are preferable, and, moreover, silicon oxide, aluminum oxide, titanium oxide, etc., may be used effectively.

In terms of abrasion resistance and optical transmittance of the surface layer 93, the average primary particle diameter of the inorganic fine particles is preferably 0.01-0.5 μm.

The average primary particle diameter of the inorganic fine particles of less than or equal to 0.01 μm could cause a decrease in the abrasion resistance, a decrease in the dispersibility, etc., whereas that of greater than or equal to 0.5 μm could promote sedimentability of the inorganic fine particles in the dispersant, or cause filming of toner to occur.

The higher the additive quantity of the inorganic fine particles the higher the abrasion resistance, which is desirable; however, when the additive quantity is too high, it could cause a rise in the residual potential and a decrease in the writing light transmittance of the protective layer, causing a side effect. Therefore, relative to generally all solid portions, it is less than or equal to 30 wt %, and, preferably less than or equal to 20 wt %. A lower limit value thereof is normally 3 wt %.

Moreover, these inorganic fine particles can be surface treated with at least one type of surfactant, which is preferable in terms of the dispersibility of the inorganic fine particles.

A decrease in the dispersibility of the inorganic fine particles causes not only a rise in the residual potential, but also a decrease in the transparency of the coating film and an occurrence of the coating film fault as well as a decrease in the abrasion resistance, which could develop into a significant problem which could prevent an increase in durability or picture quality.

Next, a case in which the photosensitive layer 92 is a monolayer configuration is described.

The photosensitive body 10 in which the above-described charge generating material is dispersed in the binder resin may be used. The mono-layer photosensitive layer 92 may be formed by dissolving or dispersing the charge generating material and the charge transporting material and the binder resin in an appropriate solvent and coating and drying them.

Moreover, the inorganic fine particles are contained even when the mono-layer photosensitive layer 92 serves as the surface layer 93.

Moreover, the photosensitive layer 92 may be desirably used by setting it to be a functional separation type in which the above-described charge transporting material is added.

Moreover, as needed, a plasticizer, a labeling agent, an oxidation inhibitor, etc., may also be added. As the binder resin, the binder resin listed previously for the charge transporting layer 922 may be used as it is in addition to combining with the binder resin listed for the charge generating layer.

The quantity of the charge generating material relative to the binder resin 100 weight parts is preferably 5-40 weight parts, whereas the quantity of the charge transport material is preferably 0-190 weight parts, and, more preferably, 50-150 weight parts.

The mono-layer photosensitive layer 92 may be formed by coating, with dip coating, spray coating, beat coating, etc., a coating liquid in which is dispersed by a dispersive apparatus, etc., using a solvent such as tetrahydrofuran, dioxane, dichloroethane, cyclohexane, etc., the charge generating material and the binder resin as well as the charge transporting material, if needed.

The film thickness of the mono-layer photosensitive layer 92 is suitably around 5-25 μm.

Moreover, in the photosensitive body 10 according to the present embodiment, the under coat layer 94 may be provided between the conductive supporting body 91 and the photosensitive layer 92.

The under coat layer 94 generally has resins as main ingredients; taking into account that the resins are to have the photosensitive layer 92 coated thereon with a solvent, they are desirably resins with a high solvent resistance to a general organic solvent.

Such resins include water-soluble resins such as polyvinyl alcohol, casein, sodium polyacrylate, etc., alcohol-soluble resins such as copolymer nylon, methoxy methylated nylon, etc., curable resins forming a three-dimensional mesh structure such as polyurethane, melamine resin, phenolic resin, alkyd/melanin resin, epoxy resin, etc.

Moreover, in the under coat layer 94, in order to prevent moire and decrease the residual potential, fine powder pigments of metal oxides which may be exemplified by titanium oxide, silica, almina, zirconia, tin oxide, indium oxide, etc., may be added.

This under coat layer 94 may be formed using an appropriate solvent and coating as in the previously-described photosensitive layer 92.

Moreover, as the under coat layer 94, a silane coupling agent, a titanium coupling agent, a chrome coupling agent, etc., may be used.

In addition, for the under coat layer 94, Al₂O₃ provided by anodization and organic matter such as polyparaxylene (parylene), and inorganic matter such as SiO₂, SnO₂, TiO₂, ITO, CeO₂, etc., that are provided in a vacuum thin film creating method may also be desirably used. In addition, other known matter may be used.

The film thickness of the under coat layer 94 is suitably 1-5 μm.

According to the photosensitive body 10 of the present embodiment, the surface layer 93 may be provided which has included inorganic fine particles in a surface-most face of the photosensitive body 92.

The surface layer 93 includes at least the inorganic fine particles and the binder resin. For the binder resin, a thermoplastic resin such as polyarylate resin, polycarbonate resin, etc., and a crosslinked resin such as urethane resin, phenolic resin, etc., are used.

As fine particles, organic fine particles and inorganic fine particles are used. The organic fine particles include fluorine-containing resin fine particles, carbon fine particles, etc. Materials for the inorganic fine particles include powder of metals such as copper, tin, aluminum, indium, etc., metal oxides such as silicon oxide, silica, tin oxide, zinc oxide, titanium oxide, indium oxide, antimony oxide, bismuth oxide, antimony-doped tin oxide, tin-doped indium oxide, etc., an inorganic material such as titanic acid potassium, etc. In particular, the metal oxides are preferable, and, moreover, silicon oxide, aluminum oxide, titanium oxide, etc., may be used effectively.

In terms of abrasion resistance and optical transmittance of the surface layer 93, the average primary particle diameter of the inorganic fine particles is preferably 0.01-0.5 μm. The average primary particle diameter of the inorganic fine particles of less than or equal to 0.01 μm could cause a decrease in the abrasion resistance, a decrease in the dispersibility, etc., whereas that of greater than or equal to 0.5 μm could promote sedimentability of the inorganic fine particles in the dispersant, or cause filming of toner to occur.

The higher the inorganic fine particle concentration within the surface layer 93 the higher the abrasion resistance, which is desirable; however, when the concentration is too high, it could cause a rise in the residual potential and a decrease in the writing light transmittance of the protective layer, possibly causing a side effect. Therefore, relative to generally all solid portions, it is less than or equal to 50 wt %, and, preferably less than or equal to 30 wt %. A lower limit value thereof is normally 5 wt %.

Moreover, these inorganic fine particles can be surface treated with at least one type of surfactant, which is preferable in terms of the dispersibility of the inorganic fine particles.

A decrease in the dispersibility of the inorganic fine particles causes not only a rise in the residual potential, but also a decrease in the transparency of the coating film and an occurrence of the coating film fault as well as a decrease in the abrasion resistance, which could develop into a significant problem of preventing an increase in durability or picture quality.

As the surfactant, a surfactant used in the related art may be used; however, a surfactant which may maintain the insulability of the inorganic fine particles is preferable.

For example, in terms of image blurring and the dispersibility of the inorganic fine particles, a titanate coupling agent, an aluminum coupling agent, a zircoaluminate coupling agent, higher fatty acid, etc., or a mixed treatment of these and a silane coupling agent; Al₂O₃, TiO₂, ZrO₂, silicone, stearic acid aluminum, etc., or a mixed treatment thereof are more preferable.

Although the treatment by the silane coupling agent increases the effect of the image blurring, the mixed treatment of the above-described surfactant and the silane coupling agent may be applied to suppress the effect thereof.

Although the amount of surface treatment varies depending on the average primary particle diameter of the inorganic fine particles used, 3-30 wt % is suitable and 5-20 wt % is more suitable. If the amount of surface treatment is smaller than the above-described amounts, the dispersion effect of the inorganic fine particles is not obtained, whereas an excessively large amount of surface treatment causes a remarkable rise in the residual potential.

These inorganic fine particles-materials are used alone, or at least two types thereof may be used in combination.

The film thickness of the surface layer 93 is preferably in a range of 1.0-8.0 μm.

The photosensitive body 10 which is repeatedly used over a long time is arranged to be what is mechanically highly durable and is difficult to wear out. However, when ozone, NOx gas, etc., are produced in the charging roller 41, etc., within the printer 100 and adhere onto a surface of the photosensitive body 10, an image drift may occur. In order to prevent such an image drift, it is necessary to cause the photosensitive layer 92 to be worn away with at least a certain rate. When such repeated use over the long term is taking into account, the surface layer 93 preferably has the film thickness of at least 1.0 μm. Moreover, if the film thickness of the surface layer 93 is greater than 8.0 μm, there is a possibility of an increase in the residual potential or a decrease in the reproducibility of fine dots.

The inorganic fine particles-materials may be dispersed by using a suitable dispersing machine. Moreover, in terms of the transmittance of the surface layer 93, the average particle diameter of the inorganic fine particles within the dispersant is less than or equal to 1 μm, preferably less than or equal to 0.5 μm.

As a method of providing the surface layer 93 on the photosensitive layer 92, dip coating, ring coating, spray coating, etc., may be used. Out of these, as a general method of fabricating a film of the surface layer 93, a spray coating method is used which adheres, onto the photosensitive layer 92, minute liquid droplets which are generated by ejecting and atomizing paint from a nozzle having a minute opening to form a coating film. Solvents used here include tetrahydrofuran, dioxane, toluene, dichloromethane, monochlorobenzene, dichloroethane, cyclohexanone, methyl ethyl ketone, acetone, etc.

In order to reduce the residual potential and improve the responsiveness, the surface layer 93 may contain the charge transporting material. For the charge transporting material, the materials listed where the charge transporting layer is described may be used. When a low molecule charge transporting material is used as the charge transporting material, a concentration gradient may be included in the surface layer 93.

Moreover, for the surface layer 93, a high-molecule charge transporting substance having a function as the binder resin and a function as the charge transporting substance is also preferably used. The surface layer 93 including these high-molecule charge transport substances is superior in abrasion resistance. Although known materials may be used as the high-molecule charge transport substances, they are preferably at least one polymer selected from polycarbonate, polyurethane, polyester, and polyether. In particular, the polycarbonate having a triaryl amine structure in a main chain and/or a side chain thereof is preferable.

The surface layer 93 of the photosensitive body 10 preferably has a Martens hardness of at least 190 N/mm² and an elasticity work rate (a We/Wt value) of at least 37.0%. The Martens hardness and the elasticity work rate are measured under the following conditions:

Evaluation apparatus: Fisherscope H-100
Test method: load/unload test repeated (once)
Indenter: micro-Vickers indenter
Maximum load: 9.8 mN
Load (unload) time: 30 s
Hold time: 5 s

When the Martens hardness is less than 190 N/mm², a failure occurs where the toner adheres to the surface of the photosensitive body. Moreover, when the elasticity work rate (We/Wt value) is less than 37.0%, the speed of photosensitive body abrasion changes, such as when an image area rate changes in an axial direction of the photosensitive body, causing a failure in which an abrasion irregularity occurs. Therefore, the resin type and the additive amount of the inorganic fine particles control the hardness and the elasticity work rate. Taking in a rigid structure in a frame of resins such as polycarbonate, polyarylate, etc., causes the hardness and the elasticity work rate to improve. Moreover, the high molecule charge transport substance is adopted to cause the hardness and the elasticity work rate to improve.

Next, the toner used in the printer 100 of the present embodiment is described. In the present printer 100, with an aim to save energy in the fixing apparatus 90 of the image forming apparatus, a low temperature fixing toner whose glass transition temperature (Tg) is to be 40-60° C. is adopted.

First, the background for adopting the low temperature fixing toner according to the present embodiment is described in detail.

As a method of fixing the image forming apparatus, in view of the superior energy efficiency, a heating roller method is widely adopted which fixes a recording paper onto which a toner image is transferred while placing the recording paper in between a pair of rollers including a heating roller and conveying the recording paper therewith.

In recent years, in order to achieve energy saving by low temperature toner fixing, there is a tendency for thermal energy provided to the toner at the time of fixing to be less. In particular, for energy saving, in order to reduce as much as possible a power amount needed for a waiting time (a warmup (recovery) time of an apparatus) from when the image forming apparatus is brought to be usable to when image forming is made possible, a reduction of the waiting time is in strong demand.

In a DSM (Demand-side-Management) program of the International Energy Agency (IEA) in fiscal year 1999, there is a technical procurement project for next generation copy machines and the requirement specifications are published therein. According to the above-described publication, for the copy machine of at least 30 cpm, achieving a dramatic saving in energy relative to related art copying machines is being called for, such that the waiting time is brought to less than or equal to 10 seconds and the power consumption during the waiting time is brought to less than or equal to 10-30 watts (varying with a copying speed).

As one way for achieving this requirement, a method is possible which causes the temperature responsiveness of the toner to improve by reducing the thermal capacity of the fixing member such as the heating roller, etc. In order to achieve the requirement and minimize the waiting time, it is considered that decreasing the fixing temperature of the toner itself and decreasing the toner fixing temperature at the time the apparatus is brought to be usable is a mandatory matter for technical achievement.

However, when seeking to achieve low temperature fixing of the toner, there is a problem that it becomes difficult to maintain the heat preservation resistance and secure the fixing temperature range (hot-offset resistance). Studies of making the hot-offset resistance and the low-temperature fixability of the toner include using polyester resin for toner binder resin (see JP2000-89514A, JP2001-356527A, JP2002-82484A, JP2002-162773A, for example).

Although it is necessary to have a resin design in which the molecular weight of the binder resin is further reduced and sharp melting properties are emphasized in order to maintain the superior low-temperature fixability, a problem occurs in which the heat preservation resistance is degraded due to a decrease in the glass transition temperature (below-called a glass transition point).

Moreover, a toner which is superior in all of the low-temperature fixability, hot offset resistance, and heat preservation resistance can be obtained by a manufacturing method including a molecular weight increasing process which causes isocyanate group-containing polyester prepolymer to undergo a polyaddition reaction with amine in an organic solvent and an aqueous medium (see JP2002-287400A, JP2002-351143A, for example).

However, even in the above-described manufacturing method, in order to satisfy the low-temperature fixability of the toner, the sharp melting property of the polyester resin, which is a base resin, is insufficient.

In light of the above-described problems, the toner for use in the printer 100 according to the present embodiment is a low-temperature fixing toner which may maintain the heat preservation resistance while having the low-temperature fixability and the hot offset resistance that are at a level not achieved in the related art. This enables energy saving to be achieved at a level not possible in the related art.

The low-temperature fixing toner for use in a printer according to the present embodiment has the following characteristics:

1. An electrostatic charge image developing toner including at least a binder resin and a coloring agent, wherein the binder resin includes a polyester resin satisfying conditions 1)-4) below; and a modified polyester resin, and wherein the glass transition point of the toner is 40-60° C.:

1) The glass transition point (Tg) is 39-65° C.;

2) A value (Mw/Tg) in which the weight average molecular weight (Mw) of a THF soluble portion is divided by the glass transition point (Tg/° C.) is 40-120;

3) A molar ratio of a benzene ring frame and a 1.4-cyclohexylene frame (the benzene ring frame/the 1.4-cyclohexylene frame) is 2.0-15.0, and a molar ratio of a benzene frame and an alkylene frame having ester bonds at both ends (the benzene frame/both ends ester bonded alkylene frame) is at least 3.0; and

4) The weight average molecular weight of the THF soluble portion is 2,000-7,800;

2. The polyester resin is characterized by the acid value of 1.0-50.0 [KOHmg/g];
3. The electrostatic charge image developing toner is characterized by the acid value of 0.5-40.0 [KOHmg/g];
4. The electrostatic charge image developing toner is characterized by the volume average particle diameter (Dv) of 3-8 μm;
5. The electrostatic charge developing toner is characterized by a ratio (Dv/Dn) of the volume average particle diameter (Dv) and the number average particle diameter (Dn) in a range of 1.00-1.25;
6. The electrostatic charge image developing toner is characterized by the average perround of 0.92-1.00;
7. The electrostatic charge image developing toner is characterized by the BET relative surface area of 1.0-6.0 m²/g;
8. The electrostatic charge image developing toner is characterized by mixing a wax, a coloring agent, a compound having an active hydrogen group, a polymer having a part which can react with the compound having the active hydrogen group, and the polyester resin, kneading, and powdering; and
9. The electrostatic charge image developing toner is characterized by being obtained by dissolving or dispersing, in an organic solvent, the wax, the coloring agent, the polymer having the part which can react with the compound having the active hydrogen group, and the polyester resin, dispersing the solvent or the dispersant in an aqueous medium, and causing the compound having the active hydrogen group to react with the polymer having the part which can react with the compound having the active hydrogen group.

Below, an embodiment of the low temperature fixing toner having the above-described characteristics is described in detail.

In order to provide a toner which is superior in all of low temperature fixability, hot offset resistance, and heat preservation resistance, a polyester resin which meets conditions of: 1) the glass transition point (Tg) of between 39° C. and 65° C.; and 2) a value (Mw/Tg) in which the weight average molecular weight (Mw) of the THF soluble portion is divided by the glass transition point (Tg/° C.) is 40-120 is used as the binder resin for the electrostatic charge image developing toner.

With a related art polyester resin, Mw tends to decrease rapidly as Tg is decreased from 65° C., and it is difficult to meet all of the low temperature fixability, the hot offset resistance, and the heat preservation resistance. When Tg of the polyester resin is below 39° C., the heat preservation resistance cannot be improved regardless of how much Mw is adjusted. Therefore, as a range in which a balance of physical properties of the toner is kept, Tg is set to be 39-65° C. and a value of Mw/Tg is set to be 40-120. As the value of Mw/Tg is in the above-described range, the polyester resin has Tg with which the heat preservation resistance may be maintained, and a decreased molecular weight is achieved, making it possible to further improve the low temperature fixability of the toner and maintain the heat preservation resistance.

Mw and Tg are obtained by the following measurement method and a unit of Tg in the value of Mw/Tg is ° C.

The glass transition point (Tg) is measured under the conditions of a temperature raising rate of 10° C./min by Rigaku THRMOFLEX TG8110 manufactured by Rigaku Corporation.

Moreover, the molecular weight is measured as follows using GPC (Gel permeation chromatography). A column is stabilized in a heat chamber of 40° C., THF as a solvent is caused to flow in the column at this temperature at a flow rate of 1 ml per minute, and a resinous THF sample solution of 50-200 μl that is prepared to 0.05-0.6 wt % as a sample concentration is poured therein to conduct the measurement. In measuring the molecular weight of the sample, the molecular weight distribution of the sample is calculated from the relationship between the number of counts and a logarithmic value of a calibration curve made using a few types of mono-dispersion polystyrene standard samples. As the standard polystyrene sample for making the calibration curve, those manufactured by Pressure Chemical Co., or Toyo Soda Kogyo K.K. with the molecular weight of 6×10², 2.1×10³, 4×10³, 1.75×10⁴, 5.1×10⁴, 1.1×10⁵, 3.9×10⁵, 8.6×10⁵, 2×10⁶, 4.48×10⁶ are used, and at least around 10 items of standard polystyrene samples are suitably used. Moreover, for a detector, an RI (refractive index) detector is used.

As the polyester resin which meets the above-described conditions, the chemical structure thereof preferably has the following characteristics: A molar ratio of a benzene ring frame and a 1.4-cyclohexylene frame (the benzene ring frame/the 1.4-cyclohexylene frame) that are contained in the polyester resin is 2.0-15.0, and a molar ratio of a benzene frame and an alkylene frame having ester bonds at both ends (the benzene frame/both ends ester bonded alkylene frame) is at least 3.0.

The glass transition point (Tg) of the polyester resin is primarily governed by the chemical structure, so that as the benzene ring frame continues and the greater the content, the higher the Tg tends to be. Moreover, the longer the alkylene frame and the greater the content, the lower the Tg tends to be. Therefore, when the content of the benzene ring frame is great, the hot offset resistance and the heat preservation resistance increases, but it becomes disadvantageous for the low temperature fixability, whereas, when the content of the alkylene frame is great, it becomes advantageous for the low temperature fixability, but it is detrimental to the hot offset resistance and the heat preservation resistance. On the other hand, causing 1.4-cyclohexylene frame to be contained in an appropriate amount makes it possible to achieve adjustment of the resinous weight average molecular weight while maintaining Tg, making it possible to further improve the low temperature fixability.

Then, the range of the molar ratio (the benzene ring frame/the 1.4-cyclohexylene frame) and the molar ratio (the benzene frame/both ends ester bonded alkylene frame) is specified as described above. When the molar ratio (the benzene ring frame/the 1.4-cyclohexylene frame) is less than 2.0, the polyester resin becomes fragile, so that the durability of the toner itself is lost. When the molar ratio (the benzene ring frame/the 1.4-cyclohexylene frame) is greater than 15.0, achieving a decreased molecular weight while maintaining the glass transition point becomes difficult, so that the low temperature fixability is not manifested. Moreover, when the molar ratio (the benzene ring frame/both ends ester bonded alkylene frame) is less than 3.0, maintaining the heat preservation resistance is difficult.

The molar ratio (the benzene ring frame/the 1.4-cyclohexylene frame) and the molar ratio (the benzene frame/both ends ester bonded alkylene frame) may be calculated by the charge composition ratio of polyalcohol and polyvalent carboxylic acid to be a resinous raw material. Moreover, it may also be calculated by measuring 1H-NMR (nuclear magnetic resonance) of the resin produced.

In order to maintain the heat preservation resistance while having the low temperature fixability and the hot offset resistance, it is important to adjust the weight average molecular weight (Mw) of the polyester resin, and it is preferable to design the Mw of the THF soluble portion of the polyester resin according to the present invention to fall between 2,000 and 7,800. This is because, when the MW is less than 2,000, the oligomer component increases, so that, as described above, even when the chemical structure is controlled, the heat preservation resistance worsens; whereas, when the oligonomer component exceeds 7,800, the melting temperature increases and the low temperature fixability worsens.

Moreover, the acid value of the polyester resin can be set to 1.0-50.0 KOHmg/g to increase the quality of toner characteristics such as the low temperature fixability, the hot offset resistance, the heat preservation resistance, and charging stability.

The low temperature fixing toner according to the present embodiment may be manufactured by mixing a polymer (below called “a prepolymer”) having a part reactive with a compound having an active hydrogen group as described in detail below, besides using the above-described polyester resin as a binder resin. This prepolymer may be mixed with the compound having the active hydrogen group to cause an extension, bridging reaction, etc., to be performed in the toner manufacturing process to achieve an improvement of the above-described toner characteristics.

Here, when the acid value of the polyester resin exceeds 50.0 KOHmg/g, the extension or bridging reaction of the prepolymer becomes insufficient, affecting the hot offset resistance; moreover, when it is less than 1.0 KOHmg/g, the extension or bridging reaction easily proceeds, causing a problem in the manufacturing stability.

The acid value of the polyester resin is measured in accordance with a JIS K0070-compliant method. When a sample does not dissolve, solvents such as THF, dioxane, etc., are used.

According to further investigations, for the low temperature fixability and the hot offset resistance, the acid value of the toner as well as the acid value of the polyester resin are important. The acid value of the toner is preferably set to 0.5-40.0 KOHmg/g. When the acid value of the toner exceeds 40 KOHmg/g, the extension or bridging reaction of the prepolymer becomes insufficient, affecting the hot offset resistance; moreover, when it is less than 0.5 KOHmg/g, the extension or bridging reaction of the prepolymer easily proceeds, causing a problem in the manufacturing stability. The acid value of the toner may be measured in the same manner as the acid value of the polyester resin.

The glass transition point of the toner is preferably 40-60° C. in order to obtain the low temperature fixability, the heat preservation resistance, and high durability. When the glass transition point is below 40° C., blocking of the toner in the developer and filming on the photosensitive body easily occur, and, when it exceeds 60° C., the low temperature fixability easily worsens. The glass transition point of the toner may be measured in the same manner as measuring the glass transition point of the polyester resin.

For the low temperature fixing toner according to the present embodiment, the volume average particle diameter (Dv) of the toner is preferably 3-8 μm, and a ratio (Dv/Dn) thereof with the number average particle diameter (Dn) is in the range of 1.00-1.25. The Dv/Dn can be specified in this way to obtain a high resolution and high image quality toner. Moreover, in order to obtain a higher quality image, it is preferable to set the Dv to 3-7 μm, the Dv/Dn to 1.00-1.20, and the particles which are less than or equal to 3 μm in unit % to 1-10 unit %. It is more preferable to set the Dv to 3-6 μm, and the Dv/Dn to 1.00-1.15. These toners are superior in all of the heat preservation resistance, the low temperature fixability, and the hot offset resistance and are superior in the glossiness of an image when used in a full-color copying machine, etc., in particular. Moreover, in a two-component developer, even when the toner is contained therein over a long term, fluctuations in the particle diameter of the toner within the developer decrease, so that superior and stable developability is obtained even in long-term agitating in a developing apparatus.

Using Coulter Counter TA-11 type, PC 9801 and connecting a personal computer (manufactured by NEC) and an interface which outputs a number distribution and a volume distribution, the average particle diameter and particle size distribution of the toner were measured.

The low temperature fixing toner according to the present embodiment has preferably the average peround of 0.92-1.00. This makes it possible to form a fine resolution image with superior reproducibility at an appropriate image density. For the average peround of less than 0.92, it is difficult to obtain a high picture quality image with satisfactory transferability or without dust particles.

The average peround of the toner may be measured by a flow-type particle image analyzing device FPIA-2000 (manufactured by Toa Medical Electronics Co., Ltd.). As a specific measurement method, 0.1-0.5 ml of a surfactant, preferably alkyl benzene sulfonate, as a dispersant is added into 100-150 ml of water in a container, in which water solid impure particles are removed in advance, and, further, a measurement sample of around 0.1-0.5 g is added thereinto. A suspension in which the sample is dispersed is obtained by undergoing the dispersion process for approximately 1-3 minutes using an ultrasonic disperser and measuring the shape and distribution of the toner by the above-described device with the dispersant concentration of 3000-10,000 number/μl.

Moreover, the low-temperature fixing toner according to the present embodiment preferably has the BET relative surface area of 1.0-6.0 m²/g. When the BET relative surface area is less than 1.0 m²/g, the picture quality decreases due to the presence of coarse particles or inclusion of additives. Moreover, when it exceeds 6.0 m²/g, the picture quality decreases due to the presence of fine particles, additives rising to the surface, or concave-convexity of the surface.

The BET relative surface area of the toner is measured using equipment units which can meet JIS standards (Z8830 and R1626), such as NOVA series manufactured by Yuasa Ionics, Ltd.

Next, materials used for the low temperature fixing toner according to the present embodiment are described in detail. The polyester resin is obtained by polycondensation of polyol (PO) and polyvalent carboxylic acid (PC).

Examples of the polyol compound (PO) include diols (DIO) and tri- or higher valent polyols (TO) and it is preferably the (DIO) alone, or a mixture of the (DIO) and a small amount of the (TO).

Examples of the diol (DIO) include alkylene glycols (ethylene glycol, 1,2-propylene glycol, 1,3-propylene glycol, 1,4-butanediol, 1,6-hexanediol, etc.); alkylene ether glycols (diethylene glycol, triethylene glycol, dipropylene glycol, polyethylene glycol, polypropylene glycol, polytetramethylene ether glycol, etc.); alicyclic diols (1,4-cyclohexanedimethanol, hydrogen-added bisphenol A, etc.); bisphenols (bisphenol A, bisphenol F, bisphenol S, etc.); alkylene oxides (ethylene oxide, propylene oxide, butylene oxide, etc.) additives of the above-described alicyclic diols; alkylene oxides (ethylene oxide, propylene oxide, butylene oxide, etc.) additives of the above-described bisphenols, etc. Of these, it is particularly preferable to use together the alkylene oxide additives of the bisphenols, the alicyclic diols, and alkylene glycols with the number of carbon atoms of 2-12.

The tri- or higher valent polyols (TO) include 3-8 or more polyvalent aliphatic alcohols (glycerin, trimethylol ethane, trimethylol propane, pentaerythritol, sorbitol, etc.); tri- or more valent phenols (trisphenol PA, phenol novolac, cresol novolac, etc.); and alkylene oxide additives of the above-described tri- or more valent polyphenols.

Examples of the polyvalent carboxylic acid (PC) include di-valent carboxylic acids (DIC) and tri- or higher valent polyvalent carboxylic acids (TC) and the PC is preferably the (DIC) alone, or a mixture of the (DIC) and a small amount of the (TC).

Examples of the di-valent carboxylic acids (DIC) include alkylene dicarboxylic acids (succinic acid, adipic acid, sebacic acid, etc.); alkenylene dicarboxylic acids (maleic acid, fumaric acid, etc.); aromatic dicarboxylic acids (phthalic acid, isophthalic acid, terephthalic acid, naphthalenedicarboxylic acid, etc.), etc. Of these, the alkylene dicarboxylic acid with the number of carbon atoms of 4-20 and the aromatic dicarboxylic acid with the number of atoms of 8-20 are preferable.

The tri- or higher valent polyvalent carboxylic acids (TC) include aromatic polyvalent carboxylic acids (trimellitic acid, pyromellitic acid, etc.), etc., with the number of atoms of 9-20. As the polyvalent carboxylic acid (PC), lower alkyl esters (methyl ester, ethyl ester, isopropyl ester, etc.) or acid anhydrides of the above may be used to react with the polyol (PO).

As an equivalent ratio [OH]/[COOH] of a hydroxyl group [OH] and a carboxyl group [COOH], the ratio of the polyol (PO) and the polyvalent carboxylic acid (PC) is normally 2/1-1/1, preferably 1.5/1-1/1, and more preferably 1.3/1-1.02/1.

The prepolymer used in the present embodiment is preferably a polyester prepolymer (A) containing an isocyanate group and may be obtained by further reacting a polyester having an active hydrogen group and a polycondensate of the polyvalent carboxylic acid (PC) and the polyol (PO) with a polyvalent isocyanate (PIC). In this case, examples of the active hydrogen group contained in the polyester include hydroxyl groups (an alcoholic hydroxyl group and a phenolic hydroxyl group), an amino group, a carboxyl group, a mercapto group, etc., and, of these, the alcoholic hydroxyl group is preferable.

As the polyols (PO), the same compounds as those used in manufacturing the above-described polyester resin may be exemplified; of these, the alkylene oxide additives of the bisphenols and the alkylene glycols with the number of carbon atoms of 2-12 are preferable; and the alkylene oxide additives of the bisphenols and use of the alkylene glycol with the number of carbon atoms of 2-12 together therewith is particularly preferable.

As the polyvalent carboxylic acids (PC), the same compounds as those used in manufacturing the polyester resin may be exemplified; of these, the alkenylene dicarboxylic acid with the number of carbon atoms of 4-20 and the aromatic dicarboxylic acid with the number of carbon atoms of 8-20 are preferable.

As the equivalent ratio [OH]/[COOH] of the hydroxyl group [OH] and the carboxyl group [COOH], the ratio of the polyol (PO) and the polyvalent carboxylic acid (PC) is normally 2/1-1/1, preferably 1.5/1-1/1, and more preferably 1.3/1-1.02/1.

Examples of the polyvalent isocyanate (PIC) include aliphatic polyvalent isocyanates (tetramethylene diisocyanate, hexamethylene diisocyanate, 2,6-diisocyanatemethylcaproate, etc.); alicyclic polyisocyanates (isophorone diisocyanate, cyclohexyl methane diisocyanate, etc.); aromatic diisocyanates (tolylene diisocyanate, diphenyl methane diisocyanate, etc.); aromatic-aliphatic diisocyanates (α,α,α′,α′-tetramethyl xylene diisocyanate, etc.); isocyanurates; the above-described polyvalent isocyanates blocked by a phenol derivative, oxime, caprolactum, etc.; and a combination of at least two types thereof.

When obtaining the polyester prepolymer (A) having the isocyanate group, as the equivalent ratio [NCO]/[CO] of the isocyanate group [NCO]; and a hydroxyl group [OH] of polyester having a hydroxyl group, the ratio of the polyvalent isocyanate (PIC) and the polyester resin (PE) having active hydrogen is normally 5/1-1/1, preferably 4/1-1.2/1, and more preferably 2.5/1-1.5/1. The content of the polyvalent isocyanate (PIC) component in the prepolymer (A) having the isocyanate group at the end thereof is normally 0.5-40 wt %, preferably 1-30 wt %, and more preferably 2-20 wt %.

Next, as amines (B), which are compounds having an active hydrogen group, that are to be reacted with the prepolymer (A), the amines having the active hydrogen group, and/or polyvalent amines are used. In this case, the active hydrogen group includes a hydroxyl group or a mercapto group. Examples of these amines (B) include diamine (B1), tri- or higher valent polyvalent amines (B2), amino alcohol (B3), aminomercaptan (B4), amino acid (B5), and those in which amino acid groups in B1-B5 are blocked.

Examples of the diamine (B1) include aromatic diamines (phenylene diamine, diethyl toluenediamine, 4,4′-diaminodiphenylmethane, etc.); alicyclic diamines (4,4′-diamino-3,3′-dimethyldicyclohexylmethane, diaminecyclohexane, isophoronediamine, etc.); and aliphatic diamines (ethylenediamine, tetramethylenediamine, hexamethylenediamine, etc.), etc.

Examples of the tri- or higher valent polyvalent amines (B2) include diethylenetriamine, triethylenetetramine, etc.

Examples of the amino alcohol (B3) include ethanolamine, hydroxyethylaniline, etc.

Examples of the aminomercaptan (B4) include aminoethylmercaptan, aminopropylmercaptan, etc.

Examples of the amino acid (B5) include aminopropionic acid, aminocapronic acid, etc.

Examples of those in which the amino groups in B1-B5 are blocked include oxazoline compounds, ketimine compounds, etc., which are obtained from ketones (acetone, methyl ethyl ketone, methyl isobutyl ketone, etc.) and the amines of B1-B5 in the above.

Of these amines (B), the (B1); and a combination of the (B1) and a small amount of the (B2) are preferable.

Moreover, when reacting the prepolymer (A) and the amines (B), the molecular weight of isocyanate-modified polyester produced using an extension stopping agent may be adjusted as needed. Examples of the extension stopping agent include monoamines without an active hydrogen group (diethylamine, dibutylamine, butylamine, laurylamine, etc.), compounds in which these are blocked (ketamine compounds), etc. The added amount thereof is appropriately selected in relation to the molecular weight desired for urea-modified polyester produced.

As the equivalent ratio [NCO]/[NHx] of the isocyanate group [NCO] in the prepolymer (A) having the isocyanate group and the amino group [NHx] (where x denotes a number of 1-2) in the amines (B), the ratio between the amines (B) and the prepolymer (A) having the isocyanate group is normally 1/2-2/1; preferably 1.5/1-1/1.5; and more preferably 1.2/1-1/1.2.

According to the present embodiment, a resin other than the polyester resin may also be used as a binder resin in blended use as long as it contains, as the binder resin, the polyester resin whose glass transition point (Tg) and whose value (Mw/Tg) in which the weight average molecular weight (Mw) of the THF soluble portion is divided by the glass transition point (Tg/° C.) fall within the range specified in the above.

Examples of usable resins other than the polyester resin include those such as the following: Polystyrene, chloropolystyrene, poly(α-methyl styrene), styrene/chlorostyrene copolymer, styrene/propylene copolymer, styrene/butadiene copolymer, styrene/vinyl chloride copolymer, styrene/vinyl acetate copolymer, styrene/maleic acid copolymer, styrene/acrylate copolymers (styrene/methyl acrylate copolymer, styrene/ethyl acrylate copolymer, styrene/butyl acrylate copolymer, styrene/octyl acrylate copolymer, styrene/phenyl acrylate copolymer); styrene/methacrylate copolymers (styrene/methyl methacrylate copolymer, styrene/ethyl methacrylate copolymer, styrene/butyl methacrylate copolymer, styrene/phenyl methacrylate copolymer); styrene/methyl α-chloroacrylate copolymer; styrenic resins such as styrene/acrylonitrile/acrylate copolymers (homopolymers or copolymers including styrene or a styrene substitution product); vinyl chloride resin, styrene/vinyl acetate copolymers, rosin-modified maleic acid resin, phenolic resin, epoxy resin, polyethylene resin, polypropylene resin, ionomer resin, polyurethane resin, silicone resin, ketone resin; ethylene/ethyl acrylate copolymers; petroleum resins such as polyvinyl butyral resin, xylene resin, etc.; hydrogen-added petroleum resin, etc. Methods of manufacturing these resins are not particularly limited, so that any one of bulk polymerization, solution polymerization, emulsion polymerization, and suspension polymerization may be used.

As coloring agents, all known dyes and pigments may be used; examples of them include carbon black, negrosine dye, iron black, Naphthol yellow S, Hansa yellow (10G, 5G, G), cadmium yellow, yellow iron oxide, yellow ocher, chrome yellow, titanium yellow, Polyazo yellow, oil yellow, Hansa yellow (GR, A, RN, R), pigment yellow L, benzidine yellow (G, GR), permanent yellow (NCG), Balkan fast yellow (5G, R), tartrazine lake, quinoline yellow lake, anthragen yellow BGL, isoindolinone yellow, red ocher, diachylon, lead vermilion, cadmium red, cadmium-mercury red, antimony vermilion, permanent red 4R, Para Red, physay red, para-chlororthonitroaniline red, resole fast scarlet G, brilliant fast scarlet, brilliant carmine BS, permanent red (F2R, F4R, FRL, FRLL, F4RH), fast scarlet VD, Balkan fast rubin B, brilliant scarlet G, Lithol Rubin GX, permanent red FSR, brilliant carmine 6B, pigment scarlet 3B, Bordeaux 5B, toluidine maroon, Permanent Bordeaux F2K, Helio Bordeaux BL, Bordeaux 10B, BON maroon light, BON maroon medium, Eosin Lake, Rhodamine Lake B, Rhodamine Lake Y, Alizarin Lake, tioindigo red B, tioindigo maroon, oil red, quinacridone red, pyrazolone red, polyazored, chrome vermillion, benzidine orange, perinone orange, oil orange, cobalt blue, cerulean blue, alkaline blue lake, peacock blue lake, Victoria blue lake, non-metal phthalocyanine blue, phthalocyanine blue, fast sky blue, Indanthrene blue (RS, BC), indigo, sea blue, Berlin blue, anthraquinone blue, fast violet B, methyl violet lake, cobalt purple, manganese purple, dioxane violet, anthraquinone violet, chrome green, zinc green, chromium oxide, pyridine, emerald green, pigment green B, naphthol green B, green gold, acid green lake, malachite green lake, phthalocyanine green, anthraquinone green, titanium oxide, zinc white, Lithopone, and mixtures thereof may be used. The content of the coloring agent relative to the toner is normally 1-15 wt % and preferably 3-10 wt %.

The coloring agent used in the present embodiment may also be used as a master batch composited with resin. Examples of binder resins for kneading with the master batch, or manufacturing of the master batch include, besides the previously-described polyester resins include polymers of a substitution body of styrenes such as polystyrene, poly p-chlorostyrene, polyvinyl toluene, etc., and the styrenes; styrene copolymers such as styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl-α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, styrene-maleate copolymer, etc.; polymethylmethacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic acid resin, rosin, modified rosin, terpene resin, aliphatic or alicyclic hydrocarbon resin, aromatic petroleum resin, chlorinated paraffin, paraffin wax, etc.; one or a mixture thereof may be used.

The master batch may be obtained by mixing and kneading the coloring agent and the resin for the master batch while applying high shear. Here, in order to enhance the mutual interaction between the coloring agent and the resin, an organic solvent may be used. Moreover, there is also a method called a flushing method in which an aqueous paste including a coloring agent and water is mixed and kneaded with a resin and an organic solvent, the coloring agent is transferred to the resin side, and the moisture content and the organic solvent component are removed. As the wet cake of the coloring agent may be used as it is, this flushing method requires no drying and is preferably used. For mixing and kneading, a high shear dispersion apparatus such as a triple roll mill is preferably used.

Moreover, a wax as well as the binder resin and the coloring agent may be contained therein. As the wax according to the present embodiment, a known one may be used; examples of the wax include polyolefin waxes (polyethylene wax, polypropylene wax, etc.); long chain hydrocarbons (paraffin wax, Sasolwax, etc.); carbonyl group-containing waxes, etc. Of these, the carbonyl group-containing waxes are preferable.

Examples of the carbonyl group-containing waxes include polyalkanoic acid esters (Carnauba wax, montan wax, trimethylolpropanetribehenate, pentaerythritoltetrabehenate, pentaerythritoldiacetatedibehenate, glycelyl tribehenate, 1,18-octadecanedioldistearate, etc.); polyalkanol esters (tristearyl trimellitate, distearyl maleate, etc.); polyalkanoic acid amides (ethylene diamine dibehenyl amide, etc.); polyalkyl amides (tristearylamide trimellitate, etc.); dialkyl ketones (distearyl ketone, etc.), etc. Of these carbonyl group-containing waxes, the polyalkanoic acid esters are preferable.

The melting point of the wax according to the present embodiment is normally 40-160° C., preferably 50-120° C., and more preferably 60-90° C. The wax with the melting point of less than 40° C. has an adverse effect on the heat preservation resistance, whereas the wax with the melting point exceeding 160° C. is likely to cause cold offset at a time of low temperature fixing. Moreover, as a measurement value at a temperature which is 20° C. higher than the melting point, the melt viscosity of the wax is preferably 5-1000 cps and more preferably 10-100 cps. The wax with the melt viscosity exceeding 1000 cps is poor in effects in improving the hot offset resistance and low temperature fixability. The content of the wax in the toner is normally 0-40 wt % and preferably 3-30 wt %.

The low temperature fixing toner according to the present embodiment may contain a charge control agent as needed. As the charge control agent, all of the known ones may be used; examples of the charge control agent include negrosin dyes, triphenylmethane dyes, chrome-containing metal complex dyes, molybdic acid chelate pigments, rhodamine dyes, alkoxyamines, quaternary ammonium salts (including fluorine-modified quaternary ammonium salt), alkylamide, phosphorus or phosphorus compounds, tungsten or tungsten compounds, fluorine activators, metal salts of salicylic acid and salicylic acid derivatives, etc. More specifically, examples thereof include Bontron 03 (a negrosin dye), Bontron P-51 (a quaternary ammonium salt), Bontron S-34 (a metal-containing azo dye), E-82 (an oxynaphthoic acid metal complex), E-84 (a salicylic acid metal complex), and E-89 (a phenol condensate), which are manufactured by Orient Chemical Industries Co., Ltd.; TP-302 and TP-415 of quaternary ammonium salt molybdenum complex, which are manufactured by Hodogaya Chemical Co., Ltd.; Copy charge PSY VP 2038 (a quaternary ammonium salt); Copy blue PR (a triphenylmethane derivative); Copy charge NEG VP 2036 and Copy charge NX VP 434 (quaternary ammonium salts), which are manufactured by Hoechst AG; LR-147 (a boron complex) and LRA-901, which are manufactured by Japan Carlit Co., Ltd.; copper phthalocyanine; perylene; quinacridone; azo pigments; and other high molecular compounds having an organofunctional group such as quaternary ammonium salt, carboxyl group, sulfonic acid group, etc.

The amount of use of the charge control agent according to the present embodiment is determined by the type of binder resin; the presence/absence of an additive used as needed; and a toner manufacturing method including a dispersion method, although it is not limited to one method; however, it is preferably used in a range of 0.1-10 weight parts relative to 100 weight parts of the binder resin. It is preferably in a range of 0.2-5 weight parts. When it exceeds 10 weight parts, the chargeability of the toner is too high, causing the effect of a main charge control agent to decline, so that an electrostatic attraction force of a developing roller increases, causing a decrease in flowability of the developing agent and a decrease in the image density.

As an external additive for aiding the chargeability, developability, and the flowability of colored particles obtained in the present embodiment, inorganic fine particles may be used preferably. The primary particle diameter of these inorganic fine particles is preferably 5×10⁻³ to 2 μm and 5×10⁻³ to 0.5 μm in particular. Moreover, the relative surface area according to the BET method is preferably 20-500 m²/g. The proportion of use of the inorganic fine particles is preferably 0.01-5 wt % of the toner and 0.01-2.0 wt % in particular.

Specific examples of the inorganic fine particles include silica, alumina, titanium oxide, barium titanate, magnesium titanate, calcium titanate, strontium titanate, zinc oxide, tin oxide, silica sand, clay, mica, wollastonite, diatomite, chromium oxide, cerium oxide, red ocher, antimony trioxide, magnesium oxide, zirconia, barium sulphate, barium carbonate, calcium carbonate, silicon carbide, silicon nitride, etc.

In addition, they include high-molecular particles, e.g., polystyrene obtained by soap-free emulsion polymerization, suspension polymerization, or dispersion polymerization; polymer particles using thermosetting and polycondensation resins such as nylon, benzoguanamine, silicone; and methacrylate and acrylate copolymers.

These plasticizers may cause surface treatment to be carried out to increase hydrophobicity and prevent degradation of the flow characteristics and the charging characteristics even under high humidity. Examples of preferable surfactants include a silane coupling agent; a silitating agent; a silane coupling agent having an alkyl fluoride group; organic titanate coupling agents; aluminum coupling agents; a silicone oil; a modified silicone oil, etc. In particular, it is preferable to use hydrophobic silica and hydrophobic titanium oxide in which the above-described surface treatment is applied to silica and titanium oxide.

While a manufacturing method of the electrostatic charge image developing toner according to the present embodiment is exemplified below, it is not limited thereto as a matter of course. (Manufacturing of polyester resin)

Under the presence of known esterification catalysts such as tetrabutoxytitanate, dibutyltinoxide, etc., polyol (PO) and polyvalent carbonic acid (PC) are heated to 150-280° C. water produced is distilled while being depressurizing as needed to obtain polyester resin.

### (Manufacturing of Prepolymer)

The polyvalent isocyanate (PIC) is reacted at 40-140° C. with polyester having a hydroxyl group obtained in the same manner as the above-described polyester resin to obtain a polyester prepolymer (A) having an isocyanate group. When reacting the polyvalent isocyanate (PIC), a solvent may also be used as needed. Examples of usable solvents include aromatic solvents (toluene, xylene, etc.); ketones (acetone, methyl ethyl ketone, methyl isobutyl ketone, etc.); esters (ethyl acetate); amides (dimethyl formamide, dimethyl acetamide, etc.); ethers (tetrahydrofuran, etc.), etc.

### (Manufacturing of Modified Polyester Resin)

Reaction of the polyester prepolymer (A) and the amines (B) may be carried out by mixing with a different toner component material, or they may be manufactured in advance. If they are manufactured in advance, the amines (B) are reacted with the polyester prepolymer (A) at 0-140° C. to obtain a urea-modified polyester resin. In reacting the polyester prepolymer (A) with the amines (B), the solvent may be used as needed in the same manner as in the prepolymer (A). The usable solvents are as listed earlier.

### (Manufacturing of Toner: Melting, Kneading, and Crushing Method)

Toner component materials such as the coloring agent, wax, charge control agent, etc., are mechanically mixed with the polyester resin, prepolymer (A) and the amines (B). A modified polyester resin may be mixed instead of the prepolymer (A) and the amines (B). This mixing process may be carried out under normal conditions using a normal mixer, etc., using vanes to be rotated, so that there is no limitation in particular.

When the above-described mixing process is completed, then the mixture is fed into a kneader to melt and knead the fed mixture. As a melting and kneading apparatus, a monoaxial or biaxial continuous kneader and a batch type kneader using a roll mill may be used. It is important that this melting and kneading are carried out under such proper conditions as not to cause cutting of a molecular chain of a toner binding resin. More specifically, the melting and kneading should be carried out at a temperature in light of the softening point of the toner binding resin; if the temperature is excessively lower than the melting point, the cutting is severe, whereas, if it is excessively higher than the melting point, dispersion does not proceed.

When the above-described melting and kneading process is completed, then the kneaded material is crushed. In this crushing process, first it is preferable to carry out coarse crushing, followed by fine crushing. Here, techniques are preferably used of causing the material to collide with a collision plate in a jet stream to crush the collided material and mechanically crushing in a narrow gap between a mechanically rotating rotor and stator. After this crushing process is completed, the crushed material is classified in the stream by centrifugal force, etc., thereby manufacturing a toner of a predetermined particle diameter.

Moreover, in order to enhance the flowability, the preservability, the developability, and the transferability of the toner, inorganic fine particles such as the previously listed hydrophobic silica fine powder, etc., are added and mixed. While a common powder mixing apparatus is used for mixing of the external additive, it is preferable to use the apparatus provided with a jacket, etc., such that the temperature inside thereof may be adjusted. In order to change the history of the load provided to the external additive, the external additive may be added in the middle, or little by little. As a matter of course, the number of the rotations of the mixing apparatus, the rotating speed, the time, the temperature, etc., may be changed. Initially a strong load may be applied, followed by a relatively weak load, or vice versa. Examples of usable mixing facilities include a V-type mixer, a rocking mixer, a Loedige mixer, a Nauta mixer, a Henshel mixer, etc.

Examples of methods of spherizing the obtained toner include a method in which a toner component material including a toner binder resin and a coloring agent is melted and kneaded, after which the finely crushed material is mechanically spherized using a hybridizer, mechanofusion, etc., and a method, which is a so-called spray dry method, in which a toner component material is dissolved and dispersed in a solvent in which a toner binding resin is soluble, after which the material is desolventized using a spray dry apparatus to obtain a spherical toner. Moreover, while a method of heating the material in an aqueous medium to spherize the material, etc., is also included, it is not limited thereto.

### (Toner Manufacturing Method in Aqueous Medium)

As an aqueous medium for use in the present embodiment, water alone may be used, but a solvent miscible with the water may also be used together. Examples of the miscible solvents include alcohols (methanol, isopropyl alcohol, ethylene glycol, etc.), dimethylformamide, tetrahydrofuran, cellosolves (methyl cellosolve, etc.), low-grade ketones (acetone, methyl ethyl ketone, etc.), etc.

The toner particles may be formed by reacting, with the amines (B), a dispersion which includes polyester prepolymer (A) having an isocyanate group in an aqueous medium, or a modified polyester resin manufactured in advance may also be used.

Examples of a method which stably forms a dispersion including the polyester prepolymer (A) and the polyester resin in the aqueous medium include a method in which a toner component material including the polyester prepolymer (A) and the polyester resin is added in the aqueous medium to disperse the product by the shear force, etc. While the coloring agent, wax, charge control agent, etc., which are other toner component materials, may be mixed when forming the dispersant in the aqueous medium, it is more preferable to mix these toner component materials in advance, after which the mixture thereof is added into the aqueous medium to disperse the product. Moreover, according to the present embodiment, it is not necessarily required to mix the toner component materials such as the coloring agent, the wax, and the charge control agent when the particles are formed in the aqueous medium, so that they may be added after forming the particles. For example, the coloring agent may be added in a known dyeing method after forming particles which do not include the coloring agent.

### (Solid Fine Particle Dispersant)

Moreover, a solid fine particle dispersant is added in advance into an aqueous medium to cause dispersion of oil droplets in aqueous phase to be uniform. Here, the solid fine particle dispersant is arranged on the surface of the oil droplets at the time of dispersion to cause the dispersion of the oil droplets to be uniform, also preventing the oil droplets from being united and causing a toner with a sharp particle size distribution to be obtained. The solid fine particle dispersant is to be present in an aqueous medium in a shape of a solid which is poorly soluble in water and inorganic fine particles with the average particle diameter of 0.01-1 μm are preferable.

Specific examples of the inorganic fine particles include silica, alumina, titanium oxide, barium titanate, magnesium titanate, calcium titanate, strontium titanate, zinc oxide, tin oxide, silica sand, clay, mica, wollastonite, diatomite, chromium oxide, cerium oxide, red ocher, antimony trioxide, magnesium oxide, zirconia, barium sulphate, barium carbonate, calcium carbonate, silicon carbide, silicon nitride, etc. Moreover, it is also preferable to use tricalcium phosphate, calcium carbonate, colloidal titanium oxide, colloidal silica, hydroxyapatite, etc. In particular, it is preferable to use hydroxyapatite, which is synthesized by reacting sodium phosphate and calcium chloride in water under basic conditions.

While methods of dispersion are not particularly limited, known facilities may be applied thereto such as low speed shearing type, high speed shearing type, friction type, high pressure jet type, ultrasonic, etc. It is preferable to use the high speed shearing type in order to set the particle diameter of the dispersion to 2-20 μm. While the rotational speed is not particularly limited for using the high speed shearing type dispersing apparatus, it is normally 1000-30000 rpm and preferably 5000-20000 rpm. While the dispersion time is not particularly limited, it is normally 0.1-5 minutes for a batch technique. The temperature at the time of dispersion is normally 0-150° C. (when pressurized) and preferably 40-98° C. The higher temperature is preferable in that the viscosity of the dispersion including the prepolymer (A) and the polyester resin is low and the dispersion is easy.

The amount of use of the aqueous medium relative to 100 weight parts of the toner composition including the prepolymer (A) and the polyester resin is normally 50-2000 weight parts and preferably 100-1000 weight parts. When it is less than 50 weight parts, the dispersion state of the toner composition is poor, so that the toner particles of a predetermined particle diameter are not obtained. When it exceeds 20000 weight parts, it is not economical. Moreover, as needed, a dispersant may also be used. Using the dispersant is preferable in that the particle size distribution becomes sharp as well as that the dispersion is stable.

Examples of the dispersant for emulsifying and dispersing, in an aqueous medium, oil phase in which a toner composition is dispersed include anionic surfactants such as alkyl benzene sulfonic acid salt, α-olefin sulfonic acid salt, phosphate ester, etc.; cationic surfactants of an amine salt type such as alkyl amine salt, amino alcohol fatty acid derivative, polyamine fatty acid derivative, imidazoline and a quaternary ammonium salt type such as alkyl trimethyl ammonium salt, dialkyl dimethyl ammonium salt, alkyl dimethyl benzyl ammonium salt, pyridinium salt, alkyl isoquinolinium salt, Benzethonium chloride, etc.; non-ionic surfactants such as fatty acid amide derivative, polyol derivative, etc.; amphoteric surfactants such as alanine, dodecyl-(aminoethyl) glycine, di(octylaminoethyl) glycine, N-alkyl-N,N-dimethylammonium betaine.

Moreover, a surfactant having a fluoroalkyl group may be used to achieve an effect thereof with a very small amount. Examples of anionic surfactants having the fluoroalkyl group that are preferably used include fluoroalkyl carboxylic acid with the number of carbon atoms of 2-10 and metal salt thereof; perfluorooctane sulfonyl glutamic acid disodium; 3-[omega-fluoroalkyl (C6-C11) oxy]-1-alkyl (C3-C4) sulfonic acid sodium; 3-[omega-fluoroalkanoyl (C6-C8)-N ethylamino]-1-propane sulfonic acid sodium; fluoroalkyl (C11-C20) carboxylic acid and metal salt thereof; perfluoroalkyl carboxylic acid (C7-C13) and metal salt thereof; perfluoroalkyl (C4-C12) sulfonic acid and metal salt thereof; perfluorooctane sulfonic acid diethanolamide, N-propyl-N-(2-hydroxyethyl) perfluorooctane sulfonamide; perfluoroalkyl (C6-C10) sulfonamide propyl trimethyl ammonium salt; perfluoroalkyl (C6-C10)-N-ethysulfonylglycine salt; monoperfluoroalkyl (C6-C16) ethyl phosphoric acid ester, etc.

Examples of the product names include SURFLON S-111, S-112, S-113 (manufactured by Asahi Glass Co., Ltd.); Fluorad FC-93, FC-95, FC-98, FC-129 (manufactured by Sumitomo 3M Co., Ltd.); Unidyne DS-101, DS-102 (manufactured by Daikin Industries, Ltd.); Megafac F-110, F-120, F-113, F-191, F-812, F-833 (manufactured by Dainippon Ink & Chemicals, Inc.); Ektop EF-102, 103, 104, 105, 112, 123A, 123B, 306A, 501, 201, 204 (manufactured by Tochem Products Co., Ltd.); Ftergent F-100, F150 (manufactured by NEOS Company Limited), etc.

Moreover, examples of the cationic surfactants include aliphatic primary, secondary, or tertiary amine acid having a fluoroalkyl group; aliphatic quaternary ammonium salt such as perfluoroalkyl (C6-C10) sulfonamidepropyltrimethyl ammonium salt; benzalkonium salt; Benzethonium chloride; pyridinium salt; imidazolinium salt for which examples of the product names include SURFLON S-121 (manufactured by Asahi Glass Co., Ltd.); Fluorad FC-135 (manufactured by Sumitomo 3M Co., Ltd.); Unidyne DS-202 (manufactured by Daikin Industries, Ltd.); Megafac F-150, F-824 (manufactured by Dainippon Ink & Chemicals, Inc.); Ektop EF-132 (manufactured by Tochem Products Co., Ltd.); Ftergent F-300 (manufactured by NEOS Company Limited), etc.

Moreover, dispersant droplets may be stabilized by high-molecular protective colloids. Examples thereof that may be used include acids such as acrylic acid, methacrylic acid, α-cyanoacrylic acid, α-cyanomethaacrylic acid, itaconic acid, crotonic acid, fumaric acid, maleic acid, maleic anhydride; acrylic (methacrylic) monomers containing a hydroxyl group, for example, β-hydroxylethyl acrylate, β-hydroxylethyl methacrylate, β-hydroxypropyl acrylate, β-hydroxypropyl methacrylate, γ-hydroxypropyl acrylate, γ-hydroxypropyl methacrylate, 3-chloro2-hydroxypropyl acrylate, 3-chloro2-hydroxypropyl methacrylate, diethyleneglycol mono-acrylic acid ester; diethyleneglycol mono-methacrylic acid ester, glyceryl mono-acrylic acid ester, glyceryl mono-methacrylic acid ester, N-methylol acrylic amide, N-methylol methacrylamide; vinyl alcohol or esters with vinyl alcohol, for example, vinyl methyl ether, vinyl ethyl ether, vinyl propyl ether, etc.; esters of compounds containing a carboxyl group and vinyl alcohol, for example, vinyl acetate, vinyl propionate, vinyl butylate, etc.; acrylic amide, methacrylic amide, diacetone acrylic amide, or methylol compounds thereof; acid chlorides such as chloride acrylate, chloride methacrylate, etc.; homopolymers or copolymers such as those having a nitrogen atom or a heterocycle thereof, such as vinyl pyridine, vinyl pyrrolidone, vinyl imidazole, ethyleneimine, etc.; polyoxyethylenes such as polyoxyethylene, polyoxypropylene, polyoxyethylene alkyl amine, polyoxypropylene alkyl amine, polyoxyethylene alkyl amide, polyoxypropylene alkyl amide, polyoxyethylene nonylphenyl ether, polyoxyethylene lauryl phenyl ether, polyoxyethylene stearyl phenyl ester, polyoxyethylene nonylphenyl ester, etc.; celluloses such as methyl cellulose, hydroxylethyl cellulose, hydroxylpropyl cellulose, etc.

When using a substance soluble in alkali, acid such as phosphoric acid calcium salt as a dispersion stabilizer, the phosphoric acid calcium salt, etc. are dissolved by an acid such as chloric acid, etc., after which the phosphoric acid calcium salt, etc., is removed from fine particles by a method of washing by water, etc. It may also be removed by other operations such as enzymatic decomposition, etc.

When the dispersant is used, the dispersant may be left to remain on the toner particle surface; however, from a point of view of charging the toner, it is more preferable to clean the surface and remove the dispersant after the extension and/or bridging reaction.

Moreover, in order to decrease the viscosity of the toner composition, a solvent in which the polyester resin and the polyester prepolymer (A) are soluble may also be used. It is more preferable to use the solvent in that the particle size distribution is sharp. The solvent preferably is volatile with the boiling point of less than 100° C. in that removal thereof is easy. Examples of the solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc.; one or a combination of at least 2 types thereof may be used. More specifically, aromatic solvents such as toluene, xylene, etc., and halogenated hydrocarbons such as methylene chloride, 1,2-dichloroethane, chloroform, carbon tetrachloride, etc., are preferable.

The amount of use of the solvent relative to 100 weight parts of the polyester prepolymer (A) is normally 0-300 weight parts, preferably 0-100 weight parts, more preferably 25-70 weight parts. When the solvent is used, after the extension and/or bridging reaction, it is increased in temperature and removed under normal pressure or under depressurizing.

The extension and/or bridging reaction time is selected in accordance with the reactivity of a combination of amines (B) and an isocyanate group structure included in the polyester prepolymer (A); it is normally 10 minutes-40 hours and preferably 2-24 hours. The reaction temperature is normally 0-150° C. and is preferably 40-98° C. Moreover, known catalysts may be used as needed. Specific examples thereof include dibutyltin laureate, dioctyltin laureate, etc.

Manufacturing of toner of a desired shape is made possible by causing particles to be fixed by providing a process in which particles having a substantially spherical shape are deformed into a spindle shape using a device such as an agitating chamber including an agitator, an Ebara milder, a homo mixer, etc., that applies a shear force to the dispersant prior to desolventizing the obtained dispersant after undergoing the extension and/or bridging reaction; and thereafter the solvent is removed from the dispersant at less than or equal to Tg of the binder resin.

The shear force may be adjusted by the concentration of organic solvent within the particles, the viscosity, the temperature of the dispersant, the number of times of processing, the processing time of the apparatus, etc. Moreover, for the particles as well, the degree of deformation due to the shear force differs depending on a difference in the coverage ratio of the resin fine particles on the particle surface, the reactivity with a compound having an active hydrogen group, causing a difference in shape.

In order to remove the organic solvent from the obtained emulsion dispersion, a method may be adopted which gradually increases the temperature of the whole system and which causes the organic solvent within liquid droplets to undergo a complete evaporative removal. Alternatively, it is also possible to spray the emulsion dispersion in a dry atmosphere to completely remove a non-water soluble organic solvent within the liquid droplets to form toner fine particles and also cause an aqueous dispersant to undergo an evaporative removal. As the dry atmosphere in which the emulsion dispersant is sprayed, a gas in which air, nitrogen, carbon dioxide, combustion gas, etc., are heated (various gas streams in which they are heated to a temperature of at least the boiling point of a solvent used that has the highest boiling point) are generally used. A spray drier, a belt drier, a rotary kiln, etc., are used to adequately obtain a target quality in a short-time process.

The dried toner powder obtained may be mixed with particles of different types, such as the charge control agent, the plasticizer, the coloring agent, etc., or a mechanical impact may be applied to the mixed powder to fix and fuse the product on the surface to prevent detaching of the particles of the different types from the surface of the composite particles obtained.

Specific methods include a method of applying an impact on the mixture by vanes to be rotated at high speed, a method of injecting and accelerating the mixture in a high speed gas stream and causing the particles themselves or the composite particles to collide with a suitable colliding plate, etc. Examples of the apparatus include a device in which crushing air pressure is decreased by modifying I-type mill (manufactured by Nippon Pneumatic Mfg. Co.), Angmill (manufactured by Hosokawa Micron Corp.), Hybridization System (manufactured by Nara Machinery Co, Ltd.), Cryptron System (manufactured by Kawasaki Heavy Industries, Ltd.), an automatic mortar, etc.

Moreover, the toner according to the present embodiment may be used as a magnetic toner containing a magnetic body; examples of magnetic materials included in the toner include metals such as iron, cobalt, nickel; iron oxides such as ferrite, hematite, magnetite, etc.; and alloys of these metals with metals such as aluminum, cobalt, copper, lead, magnesium, tin, zinc, antimony, beryllium, bismuth, cadmium, calcium, manganese, selenium, titanium, tungsten, vanadium, and mixtures thereof. In particular, magnetite is preferable in magnetic properties. These ferromagnetic bodies desirably have the average particle diameter of 0.1-2 μm; the amount to be contained in the toner is approximately 15-200 weight parts relative to 100 weight parts of resin component, and is, in particular, preferably 20-100 weight parts relative to 100 weight parts of resin component.

Examples of the low temperature fixing toner according to the present embodiment are described.

### Manufacturing Example 1

### Manufacturing Example of Polyester Resin

First, 517 parts of bisphenol A ethylene oxide 2 mol adduct, 317 parts of terephthalic acid, 101 parts of ethylene glycol, and 65 parts of hydrogen added bisphenol A were injected into a reactive chamber with a cooling tube, an agitator, and a nitrogen introducing tube, the product was subjected to a condensation reaction for 10 hours at 170° C. under a normal pressure nitrogen gas stream, after which the condensation reaction was continued for 5 hours at the reaction temperature of 210° C. Then, the product was subjected to a continuous reaction for 5 hours while being dehydrated under depressurizing at 0-15 mmHg, after which it was cooled to obtain polyester resin (PE1). For the obtained polyester resin (PE1), the weight average molecular weight (Mw) of the THF soluble portion was 2,900; the acid value was 5 KOHmg/g, the glass transition point (Tg) was 43° C., and the ratio (Mw/Tg) of the weight average molecular weight and the glass transition point was 67. Moreover, the molar ratio of the benzene ring frame and the 1,4-cyclohexylene frame was 9.5, whereas the molar ratio of the benzene ring frame and the both ends ester bonded alkylene frame was 3.2.

### (Manufacturing Example of Prepolymer)

First, 795 parts of bisphenol A ethylene oxide 2 mol adduct; 200 parts of isophthalic acid; 65 parts of terephthalic acid; and 2 parts of dibutyltinoxide were injected into a reactive chamber with a cooling tube, an agitator, and a nitrogen introducing tube; and the product was subjected to a condensation reaction for 8 hours at 210° C. under the normal pressure nitrogen gas stream. Then, the product was subjected to a continued reaction for 5 hours while being dehydrated under depressurizing at 10-15 mmHg, after which it was cooled to 80° C. and reacted for 2 hours with 170 parts of isophorone diisocyanate in ethyl acetate to obtain prepolymer (a1). For the obtained prepolymer (a1), the weight average molecular weight (Mw) of the THF soluble portion was 5,000, and the average number of organofunctional groups was 2.25.

### (Manufacturing Example of Ketimine Compound)

Thirty parts of isophorone diamine and 70 parts of methyl ethyl ketone were fed into a reactive chamber with an agitating bar and a thermometer and reacted for 5 hours at 50° C. to obtain a ketimine compound (b1).

### (Manufacturing Example of Toner)

First, 85 parts of polyester (PE1), 15 parts of prepolymer (a1), 2 parts of ketimine compound (b1), 5 parts of desolated fatty acid type carnauba wax, 10 parts of carbon black (#44: manufactured by Mitsubishi Chemical Corporation); 1 part of metal containing azo compound, and 5 parts of water were agitated and mixed in the Henshel mixer. Thereafter, the product was heated and melted for approximately 30 minutes at a temperature of 130-140° C. by the roll mill, cooled to room temperature, after which the kneaded product obtained was crushed and classified using an air classifier to obtain a toner base. 0.5 parts of hydrophobic silica was added and mixed with the obtained toner base to yield a final toner (I).

### Manufacturing Example 2

### Manufacturing Example of Polyester Resin

There were 613 parts of Bisphenol A ethylene oxide 2 mol adduct, 322 parts of terephthalic acid; 13 parts of ethylene glycol; and 52 parts of hydrogen-added bisphenol A injected into a reactive chamber with a cooling tube, an agitator, and a nitrogen introducing tube, and polyester resin (P2) was obtained in the same manner as in Manufacturing example 1. For the obtained polyester resin (PE2), the weight average molecular weight (Mw) of the THF soluble portion was 5,800; the acid value was 38 KOHmg/g, the glass transition point (Tg) was 59 and the ratio (Mw/Tg) of the weight average molecular weight and the glass transition point was 98. Moreover, the molar ratio of the benzene ring frame and the 1,4-cyclohexylene frame was 13.5, whereas the molar ratio of the benzene ring frame and the both ends ester bonded alkylene frame was 27.0.

### (Manufacturing Example of Toner)

There were 85 parts of polyester (PE2), 15 parts of prepolymer (a1), 2 parts of ketimine compound (b1), 5 parts of desolated fatty acid type carnauba wax, 10 parts of carbon black (#44: manufactured by Mitsubishi Chemical Corporation); 1 part of metal containing azo compound, and 5 parts of water agitated and mixed in the Henshel mixer. Thereafter, the product was heated and melted for approximately 30 minutes at a temperature of 130-140° C. by the roll mill, cooled to room temperature, after which the kneaded product obtained was crushed and classified using a jet mill or an air classifier to obtain a toner base. 0.5 parts of hydrophobic silica was added and mixed with the obtained toner base to yield a final toner (II).

### Manufacturing Example 3

### Manufacturing Example of Polyester Resin

There were 548 parts of Bisphenol A ethylene oxide 2 mol adduct, 296 parts of terephthalic acid; 44 parts of ethylene glycol; and 113 parts of hydrogen-added bisphenol A injected into a reactive chamber with a cooling tube, an agitator, and a nitrogen introducing tube, and polyester resin (PE3) was obtained in the same manner as in Manufacturing example 1. For the obtained polyester resin (PE3), the weight average molecular weight (Mw) of the THF soluble portion was 3,300; the acid value was 7 KOHmg/g, the glass transition point (Tg) was 43 and the ratio (Mw/Tg) of the weight average molecular weight and the glass transition point was 77. Moreover, the molar ratio of the benzene ring frame and the 1,4-cyclohexylene frame was 5.6, whereas the molar ratio of the benzene ring frame and the both ends ester bonded alkylene frame was 7.5.

### (Manufacturing Example of Toner)

There were 83 parts of polyester resin (PE3), 17 parts of prepolymer (a1), 2 parts of ketimine compound (b1), 5 parts of desolated fatty acid type carnauba wax, 10 parts of carbon black (#44: manufactured by Mitsubishi Chemical Corporation); 1 part of metal containing azo compound, and 5 parts of water agitated and mixed in the Henshel mixer. Thereafter, the product was heated and melted for approximately 30 minutes at a temperature of 130-140° C. by the roll mill, and cooled to room temperature, after which the kneaded product obtained was crushed and classified using a jet mill or an air classifier to obtain a toner base. Then, 0.5 parts of hydrophobic silica was added and mixed with the obtained toner base to yield a final toner (III).

### Manufacturing Example 4

### Manufacturing Example of Polyester Resin

There were 426 parts of Bisphenol A ethylene oxide 2 mol adduct, 350 parts of terephthalic acid; 8 parts of ethylene glycol; and 216 parts of hydrogen-added bisphenol A injected into a reactive chamber with a cooling tube, an agitator, and a nitrogen introducing tube, and polyester resin (PE4) was obtained in the same manner as in Manufacturing example 1. For the obtained polyester resin (PE4), the weight average molecular weight (Mw) of the THF soluble portion was 6,500; the acid value was 28 KOHmg/g, the glass transition point (Tg) was 62 and the ratio (Mw/Tg) of the weight average molecular weight and the glass transition point was 105. Moreover, the molar ratio of the benzene ring frame and the 1,4-cyclohexylene frame was 2.7, whereas the molar ratio of the benzene ring frame and the both ends ester bonded alkylene frame was 35.7.

### (Manufacturing Example of Prepolymer)

There were 795 parts of Bisphenol A ethylene oxide 2 mol adduct; 200 parts of isophthalic acid; 65 parts of terephthalic acid; and 2 parts of dibutyltinoxide injected into a reactive chamber with a cooling tube, an agitator, and a nitrogen introducing tube; and the product was subjected to a condensation reaction for 8 hours at 210° C. under the normal pressure nitrogen gas stream. Then, the product was subjected to a continued reaction for 5 hours while being dehydrated under depressurizing at 10-15 mmHg, after which they were cooled to 80° C. and reacted for 2 hours with 150 parts of isophorone diisocyanate in ethyl acetate to obtain prepolymer (a2). For the obtained prepolymer (a2), the weight average molecular weight (Mw) was 5,000, and the average number of organofunctional groups was 2.00.

### (Manufacturing Example of Toner)

There were 14.3 parts of prepolymer (a2); 55 parts of polyester resin (PE4); and 78.6 parts of ethyl acetate put into a beaker, agitated, and dissolved. Then separately, 10 parts of rice wax as a mold release agent, 4 parts of copper phthalocyanine blue pigment, and 100 parts of ethyl acetate were put into a beads mill and dispersed for 30 minutes. The two liquids were mixed and agitated for 5 minutes at the rotational speed of 12,000 rpm using a TK-type homo mixer, after which the product was dispersed in the beads mill for 10 minutes. This is to be called an oil-based toner material dispersion liquid (1).

Then 306 parts of ion exchange water; 265 parts of tricalcium phosphate 10% suspension; and 0.2 parts of sodium dodecylbenzenesulfonic acid were put into a beaker; 2.7 parts of ketimine compound (2) and oil-based toner material dispersing liquid (1) described above were added to this aqueous dispersing liquid while agitating for 5 minutes at the rotational speed of 12,000 rpm in a TK-type homo mixer, causing the dispersing liquid to react while continuing to agitate for 30 minutes. After an organic solvent was removed at a temperature of less than or equal to 50° C. within 1.0 hour under depressurizing, the dispersing liquid after the reaction (with the viscosity of 5,500 mPa·s was filtered, washed, dried, and then air classified to obtain a spherical toner base.

Then, 100 parts of the base particle obtained and 0.25 parts of charge control agent (Bontron E-84 manufactured by Orient Chemical Industries Co., Ltd.) were fed into a Q-type mixer (manufactured by Mitsui Mining Co., Ltd.) and were subjected to a mixing process with the speed of the turbine-type vanes set to 50 m/s. In this case, the mixing process was set to include 5 cycles of 2 minutes of operation and 1 minute of stopping for a total process time of 10 minutes. Moreover, 0.5 parts of hydrophobic silica (H2000 manufactured by Clariant Japan K.K.) was added and subjected to a mixing process. In this case, the mixing process was set to include 5 cycles of 30 seconds of mixing and 1 minute of stopping at the vane speed of 15 m/s to yield a final toner (IV).

The physical properties on the polyester resins (PE1)-(PE4) used in the toner (I)-(IV) that were described above are shown in Table 3.

TABLE 3

| | WEIGHT | | GLASS | | BENZENE RING | BENZENE RING |
|---|---|---|---|---|---|---|
| | AVERAGE | ACID | TRANSITION | | FRAME/1.4- | FRAME/BOTH ENDS |
| POLYESTER | MOLECULAR | VALUE | POINT | | CYCLOHEXYLENE | ESTER BONDED |
| RESIN | WEIGHT (Mw) | [KOHmg/g] | (Tg) [° C.] | Mw/Tg | FRAME | ALKYLENE FRAME |
| PE 1 | 2,900 | 5 | 43 | 67 | 9.5 | 3.2 |
| PE 2 | 5,800 | 38 | 59 | 98 | 13.5 | 27.0 |
| PE 3 | 3,300 | 7 | 43 | 77 | 5.6 | 7.5 |
| PE 4 | 6,500 | 28 | 62 | 105 | 2.7 | 35.7 |

### Manufacturing Example 5

### Manufacturing Example of Polyester Resin

There were 585 parts of Bisphenol A ethylene oxide 2 mol adduct, 307 parts of terephthalic acid; 71 parts of ethylene glycol; and 36 parts of hydrogen-added bisphenol A injected into a reactive chamber with a cooling tube, an agitator, and a nitrogen introducing tube, and polyester resin (PE5) was obtained in the same manner as in Manufacturing example 1. For the obtained polyester resin (PE5), the weight average molecular weight (Mw) of the THF soluble portion was 2,500; the acid value was 9 KOHmg/g, the glass transition point (Tg) was 35° C., and the ratio (Mw/Tg) of the weight average molecular weight and the glass transition point was 71. Moreover, the molar ratio of the benzene ring frame and the 1,4-cyclohexylene frame was 18.5, whereas the molar ratio of the benzene ring frame and the both ends ester bonded alkylene frame was 4.8.

### (Manufacturing Example of Toner)

There were 85 parts of polyester resin (PE5), 15 parts of prepolymer (a1), 2 parts of ketimine compound (b1), 5 parts of desolated fatty acid type carnauba wax, 10 parts of carbon black (#44: manufactured by Mitsubishi Chemical Corporation), 1 part of metal-containing azo compound, and 5 parts of water agitated and mixed in a Henshel mixer, after which the product was heated and melted for approximately 30 minutes at a temperature of 130-140° C. in a roll mill and cooled to room temperature, after which the kneaded product obtained was crushed and classified using a jet mill and an air classifier to obtain a toner base. Then 0.5 parts of hydrophobic silica was added and mixed with the obtained toner base to yield a final toner (V).

### Manufacturing Example 6

### Manufacturing Example of Polyester Resin

There were 244 parts of Bisphenol A ethylene oxide 2 mol adduct, 443 parts of terephthalic acid; 99 parts of ethylene glycol; and 214 parts of hydrogen-added bisphenol A injected into a reactive chamber with a cooling tube, an agitator, and a nitrogen introducing tube, and polyester resin (PE6) was obtained in the same manner as in Manufacturing example 1. For the obtained polyester resin (PE6), the weight average molecular weight (Mw) of the THF soluble portion was 5,700; the acid value was 18 KOHmg/g, the glass transition point (Tg) was 45° C. and the ratio (Mw/Tg) of the weight average molecular weight and the glass transition point was 127. Moreover, the molar ratio of the benzene ring frame and the 1,4-cyclohexylene frame was 2.4, whereas the molar ratio of the benzene ring frame and the both ends ester bonded alkylene frame was 2.6.

### (Manufacturing Example of Toner)

There were 14.3 parts of prepolymer (a1); 55 parts of polyester resin (PE6); and 78.6 parts of ethyl acetate put into a beaker, agitated, and dissolved. Then separately, 10 parts of rice wax as a mold release agent, 4 parts of copper phthalocyanine blue pigment, and 100 parts of ethyl acetate were put into a beads mill and dispersed for 30 minutes. The two liquids were mixed and agitated for 5 minutes at the rotational speed of 12,000 rpm using a TK-type homo mixer, after which the product was dispersed in the beads mill for 10 minutes. This is called an oil-based toner material dispersing liquid (2).

Then 306 parts of ion exchange water; 265 parts of tricalcium phosphate 10% suspension; and 0.2 parts of sodium dodecylbenzenesulfonic acid were put into a beaker; 2.7 parts of ketimine compound (b1) and oil-based toner material dispersing liquid (2) described above were added to this aqueous dispersing liquid while agitating at 12,000 rpm in a TK-type homo mixer, causing them to react while continuing to agitate for 30 minutes. After an organic solvent was removed at a temperature of less than or equal to 50° C. within 1.0 hour under depressurizing, the dispersing liquid after the reaction (with the viscosity of 3,800 mPa·s was filtered, washed, dried, and then air classified to obtain a spherical toner base.

Then 100 parts of the base particles obtained and 0.25 parts of charge control agent (Bontron E-84 manufactured by Orient Chemical Industries Co., Ltd.) were fed into a Q-type mixer (manufactured by Mitsui Mining Co., Ltd.) and were subjected to a mixing process with the speed of the turbine-type vanes set to 50 m/s. In this case, the mixing process was set to include 5 cycles of 2 minutes of operation and 1 minute of stopping for a total processing time of 10 minutes. Moreover, 0.5 parts of hydrophobic silica (H2000 manufactured by Clariant Japan K.K.) was added and subjected to a mixing process. In this case, the mixing process was set to include 5 cycles of 30 seconds of mixing and 1 minute of stopping at the vane speed of 15 m/s to yield a final toner (VI).

### Manufacturing Example 7

### Manufacturing Example of Polyester Resin

There were 393 parts of Bisphenol A ethylene oxide 2 mol adduct; 430 parts of terephthalic acid; 121 parts of ethylene glycol; and 57 parts of hydrogen-added bisphenol A injected into a reactive chamber with a cooling tube, an agitator, and a nitrogen introducing tube, and polyester resin (PE7) was obtained in the same manner as in Manufacturing example 1. For the obtained polyester resin (PE7), the weight average molecular weight (Mw) of the THF soluble portion was 5,000; the acid value was 11 KOHmg/g, the glass transition point (Tg) was 41° C., and the ratio (Mw/Tg) of the weight average molecular weight and the glass transition point was 122. Moreover, the molar ratio of the benzene ring frame and the 1,4-cyclohexylene frame was 10.8, whereas the molar ratio of the benzene ring frame and the both ends ester bonded alkylene frame was 2.6.

### (Manufacturing Example of Toner)

There were 14.3 parts of prepolymer (a2); 55 parts of polyester resin (PE7); and 78.6 parts of ethyl acetate put into a beaker, agitated, and dissolved. Then separately, 10 parts of rice wax as a mold release agent, 4 parts of copper phthalocyanine blue pigment, and 100 parts of ethyl acetate were put into a beads mill and dispersed for 30 minutes. The two liquids were mixed and agitated for 5 minutes at the rotational speed of 12,000 rpm using a TK-type homo mixer, after which the product was dispersed in the beads mill for 10 minutes. This is to be called an oil-based toner material dispersing liquid (3).

Then 306 parts of ion exchange water; 265 parts of tricalcium phosphate 10% suspension; and 0.2 parts of sodium dodecylbenzenesulfonic acid were put into a beaker; 2.7 parts of ketimine compound (b1) and oil-based toner material dispersing liquid (3) described above were added to this aqueous dispersing liquid while agitating at 12,000 rpm in a TK-type homo mixer, causing them to react while continuing to agitate for 30 minutes. After an organic solvent was removed at a temperature of less than or equal to 50° C. within 1.0 hour under depressurizing, the dispersing liquid after the reaction (with the viscosity of 7,800 mPa·s) was filtered, washed, dried, and then air classified to obtain a spherical toner base.

Then 100 parts of the base particle obtained and 0.25 parts of a charge control agent (Bontron E-84 manufactured by Orient Chemical Industries Co., Ltd.) were fed into a Q-type mixer (manufactured by Mitsui Mining Co., Ltd.) and were subjected to a mixing process at the speed of the turbine-type vanes set to 50 m/s. In this case, the mixing process was set to include 5 cycles of 2 minutes of operation and 1 minute of stopping for a total processing time of 10 minutes. Moreover, 0.5 parts of hydrophobic silica (H2000 manufactured by Clariant Japan K.K.) was added and subjected to a mixing process. In this case, the mixing process was set to include 5 cycles of 30 seconds of mixing and 1 minute of stopping at the vane speed of 15 m/s to yield a final toner (VII).

The physical properties on the polyester resins (PE5)-(PE7) used in the toner (V)-(VII) that were described above are shown in Table 4.

TABLE 4

| | WEIGHT | | GLASS | | BENZENE RING | BENZENE RING |
|---|---|---|---|---|---|---|
| | AVERAGE | ACID | TRANSITION | | FRAME/1.4- | FRAME/BOTH ENDS |
| POLYESTER | MOLECULAR | VALUE | POINT | | CYCLOHEXYLENE | ESTER BONDED |
| RESIN | WEIGHT (Mw) | [KOHmg/g] | (Tg) [° C.] | Mw/Tg | FRAME | ALKYLENE FRAME |
| PE 5 | 2,500 | 9 | 35 | 71 | 18.5 | 4.8 |
| PE 6 | 5,700 | 18 | 45 | 127 | 2.4 | 2.6 |
| PE 7 | 5,000 | 11 | 41 | 122 | 10.8 | 2.6 |

The low temperature fixability, the high temperature offset resistance, and the heat preservation resistance were evaluated using the above-described toners (I)-(IV) as examples of the low temperature fixing toner according to the present embodiment. Moreover, for comparison, using the above-described toner (V)-(VII), evaluation was carried out in the same manner. Items and methods of evaluating the toners are as follows:

### Fixability Evaluation

Using a device in which is modified a fixing unit of a copying machine MF2200 manufactured by Ricoh Company, Ltd. that uses a Teflon made roller as a fixing roller, Type 6200 paper manufactured by Ricoh was set thereto to carry out a copying test. The fixing temperature was varied to determine a cold offset temperature (lower fixing limit temperature) and a hot offset temperature (higher fixing limit temperature). The lower fixing limit temperature of the related-art low temperature fixing toner is around 140-150° C. As conditions for evaluating the low temperature fixability, the paper feed line speed of 120-150 mm/s, the face pressure of 1.2 kgf/cm², the nip width of 3 mm were set, whereas, as conditions for evaluating the hot offset, the paper feed line speed of 50 mm/s, the face pressure of 2.0 kgf/cm², and the nip width of 4.5 mm were set.

The criteria for the respective characteristic evaluations are as follows:

1) Low temperature fixability (five grade evaluation, where, in Table 5, grade 5 is denoted by a double circle; grade 4 is denoted by a circle; grade 3 is denoted by a square; grade 2 is denoted by a triangle; and grade 1 is denoted by an “X” symbol.)
grade 5: less than 130° C.; grade 4: 130-140° C.; grade 3: 140-150° C.; grade 2: 150-160° C.; and grade 1: greater than or equal to 160° C.;
2) Hot offset resistance (five grade evaluation as in 1) in the above)
5: greater than or equal to 201° C.; 4: 200-191° C. 3: 190-181° C.; 2: 180-171° C. and 1: less than 170° C.

### Heat Preservation Resistance Evaluation

There were 20 g of toner sample put into a glass bottle of 20 ml, the glass bottle was tapped approximately 50 times to densely compress the sample, after which the compressed sample was left for 24 hours in a high temperature chamber of 50° C. and then a penetration ratio tester was used to determine the penetration ratio as follows:

3) Heat preservation resistance (five grade evaluation as in 1) in the above)
grade 5: penetrated; grade 4: greater than or equal to 25 mm; 3: 25-20 mm; 2: 20-15 mm; 1: less than or equal to 15 mm

Evaluation results of the toner are shown in Table 5. As seen in Table 5, when the toners (I)-(IV) according to the present embodiment were used, results were obtained which were superior in all of the low temperature fixability, the hot offset resistance, and the heat preservation resistance. On the other hand, when the toners (V)-(VII) according to comparative examples were used, results were obtained which were superior in the low temperature fixability and the hot offset resistance, but poor in the heat preservation resistance.

TABLE 5

| | | | VOLUME | | | | | | |
|---|---|---|---|---|---|---|---|---|---|
| | | GLASS | AVERAGE | | | BET | | | |
| | ACID | TRANSITION | PARTICLE | | | RELATIVE | LOW | | HEAT |
| | VALUE | POINT | DIAMETER | | AVERAGE | SURFACE | TEMPERATURE | HOT OFFSET | PRESERVATION |
| TONER | [KOHmg/g] | (Tg) [° C.] | (DV) [μm] | Dv/Dn | PERROUND | [m²/g] | FIXABILITY | RESISTANCE | RESISTANCE |
| I | 4 | 45 | 6.7 | 1.05 | 0.92 | 5.9 | ⊚ | ⊚ | ◯ |
| II | 28 | 59 | 5.9 | 1.10 | 0.93 | 5.2 | ◯ | ◯ | ⊚ |
| III | 8 | 43 | 7.0 | 1.07 | 0.93 | 5.3 | ⊚ | ⊚ | ◯ |
| IV | 23 | 81 | 4.7 | 1.15 | 0.98 | 1.5 | ◯ | ◯ | ⊚ |
| V | 8 | 38 | 5.5 | 1.08 | 0.93 | 5.5 | ⊚ | ◯ | X |
| VI | 18 | 48 | 5.8 | 1.10 | 0.95 | 5.0 | ◯ | ⊚ | □ |
| VII | 10 | 43 | 3.2 | 1.22 | 0.98 | 1.9 | ◯ | ◯ | Δ |

What have been described are merely exemplary, so that the present invention yields advantageous effects specific to each of the following modes.

### (Mode A)

In an image forming apparatus which forms a toner image on a surface of an image bearing body such as a surface moving photosensitive body 10, etc., and eventually transfers and fixes the toner image onto a recording material to form an image on the recording material; and removes an adhered matter which adheres onto the surface of the image bearing body after the transfer, wherein the glass transition point (Tg) of the toner is 40-60° C.; the cleaning device is to cause a tip ridgeline portion of a blade member such as an elastic blade 622, etc., to be abutted against the surface of the image bearing body to remove the adhered matter from the surface of the image bearing body, and wherein the tip ridgeline portion of the blade member is made of elastic rubber whose 100% modulus value at 23° C. is at least 6 MPa.

This makes it possible to prevent filming onto an image bearing body while achieving energy saving as described in the above-described embodiment.

### (Mode B)

In (Mode A), the image bearing body has a surface layer which contains fine particles. In the image bearing body having the surface layer containing the fine particles, concave-convexity by the fine particles is formed on the image bearing body surface. In such an image bearing body, the contact area of the tip ridgeline portion (an edge portion) of the blade member and the image bearing body is smaller than that of an image bearing body containing no fine particles that has a smooth surface. Therefore, sliding frictional force between the image bearing body and the edge portion is reduced to allow suppressing of occurrence of frictional heat, so that a temperature increase in the edge portion is suppressed. Moreover, in a concave portion formed on a surface of the image bearing body, a pressing force by the blade member is reduced, making it difficult for the toner to be adhered to the concave portion. Therefore, the toner taking a film-shape on the image bearing body over time is reduced. This makes it possible to suppress filming onto the image bearing body more effectively.

### (Mode C)

In (Mode A) or (Mode B), the surface layer of the image bearing body preferably has a Martens hardness of at least 190 N/mm² and an elasticity workrate (a We/Wt value) of at least 37.0%. This makes it possible to prevent filming onto the image bearing body. Setting the Martens hardness (HM) to be at least 190N/mm² causes filming onto the surface of the photosensitive body of toner and toner additive particles to be difficult. Moreover, when the elastic work rate (We/Wt) is less than 37.0%, abrasion unevenness and change in photosensitive body abrasion speed is likely to occur in a photosensitive body axial direction when an image area is changed. At a location with much abrasion, concavity-convexity due to the surface layer is lost, causing a likelihood of occurrence of filming of the toner and toner additive agent particles to be higher.

### (Mode D)

In (Mode A), (Mode B), or (Mode C), the blade member is a laminated elastic blade which includes multiple layers which are made of materials whose 100% modulus values are mutually different, and, of the multiple layers of the elastic blade, an edge layer 622b which includes a tip ridgeline portion is formed with a material whose 100% modulus value is higher than that of a different layer such as a backup layer 622a.

This makes it possible to reduce deformation of a nip due to an effect of the edge layer 622b, which is made of a high strength material. Moreover, for the backup layer 622a, using a material with a 100% modulus value and a strength which are lower than those of the edge layer 622b cause the loss of the elasticity due to long term use and the decrease in the abutting pressure to be prevented. Therefore, this makes it possible to maintain the filming reduction effect and a superior cleaning performance over the long term and to achieve high reliability and an increased service life.

### (Mode E)

In (Mode D), the repulsion elasticity in the edge layer of the blade member is less than the repulsion elasticities in the different layer at least at 10° C. In order to prevent filming, it is effective to reduce the repulsion elasticity of the edge layer 622b; however, reducing the repulsion elasticity causes the cleaning performance under the low temperature environment to be reduced. Therefore, the repulsion elasticity of the different layer is set to be greater than the repulsion elasticity of the edge layer 622b to normalize the repulsion elasticity in the overall laminated elastic blade 622. This makes it possible to maintain the cleaning performance under the low temperature environment while preventing filming.

### (Mode F)

In (Mode D), the tan δ peak temperature of the edge layer of the blade member is higher than the tan δ peak temperature of the different layer. In order to prevent filming, it is effective to increase the tan δ peak temperature of the edge layer 622b to reduce the rubber properties under the low temperature environment and stick-slip movement of the blade; however, this causes the cleaning performance under the low temperature environment to be reduced. Therefore, the tan δ peak temperature of the different layer is decreased to enhance the rubber properties of the different layer and normalize the tan δ peak temperature in the overall laminated elastic blade 622. This makes it possible to maintain the cleaning performance under the low temperature environment while preventing filming.

### (Mode G)

In (Mode A) to (Mode F), the above-described toners are polymerized toners. This makes it possible to improve the developing properties and the transferability to obtain a fine picture quality since the polymerized toners whose shapes are uniform are used.

### (Mode H)

In (Mode A) to (Mode G), a toner image is formed onto the surface of the image bearing body after uniformly charging the surface of the image bearing body by a charging member of a charging roller 41, etc., to which a voltage is applied, and the charging member comes into contact with the image bearing body. This causes occurrence of ozone to be reduced substantially by setting the charging member to be a contact charging member.

### (Mode I)

In (Mode A) to (Mode G), a toner image is formed onto the surface of the image bearing body after uniformly charging the surface of the image bearing body by a charging member to which a voltage is applied, and the charging member opposes the image bearing body with a minute gap. The charging apparatus is equipped with a charging roller which opposes a photosensitive body with a minute gap, causing it difficult for a stain such as a toner, etc., from the photosensitive body to be adhered to the charging roller surface, making it possible to reduce the charging roller staining and achieve a longer life.

### (Mode J)

In (Mode H) or (Mode I), a voltage in which alternating current is superposed on direct current is applied to the charging member. This causes the alternating current voltage to be superposed on the direct current voltage and applied, so that the charging potential is stabilized, achieving a higher image quality and a longer service life.

### (Mode K)

In a process cartridge which can be attached to and detached from (Mode A) to (Mode J), at least one of the cleaning apparatus and a developing unit which includes an image forming body and which forms the toner image is integrally formed. This facilitates the operability at the time of maintenance.

The present application is based on and claims the benefit of priority of Japanese Application No. 2013-032459 filed on Feb. 21, 2013, the entire contents of which are hereby incorporated by reference.

1. An image forming apparatus which forms a toner image on a surface of a surface moving image bearing body and eventually transfers and fixes the toner image onto a recording medium to form an image on the recording medium and removes, by a cleaning apparatus, an adhered matter which is adhered to the surface of the image bearing body after the transferring, wherein
a glass transition temperature (Tg) of a toner is 40-60° C., wherein
the cleaning apparatus causes a tip ridgeline portion of a blade member to be abutted against the surface of the image bearing body to remove the adhered matter from the surface of the image bearing body, and wherein the tip ridgeline portion of the blade member is made of elastic rubber whose 100% modulus value at 23° C. is at least 6 MPa.

2. The image forming apparatus as claimed in claim 1, wherein the image bearing body has a surface layer containing fine particles.

3. The image forming apparatus as claimed in claim 1, wherein a surface layer of the image bearing body has a Martens hardness of at least 190 N/mm² and an elastic work rate (a We/Wt value) of at least 37.0%.

4. The image forming apparatus as claimed in claim 1, wherein
the blade member is a laminated elastic blade which includes multiple layers of materials whose 100% modulus values are mutually different, and wherein, of the multiple layers of the elastic blade, an edge layer which includes the tip ridgeline portion is formed of a material whose 100% modulus value is higher than a different layer.

5. The image forming apparatus as claimed in claim 4, wherein a repulsion elasticity of the edge layer of the blade member is less than a repulsion elasticity of the different layer at greater than or equal to 10° C.

6. The image forming apparatus as claimed in claim 4, wherein a tan δ peak temperature of the edge layer of the blade member is higher than a tan δ peak temperature of the different layer.

7. The image forming apparatus as claimed in claim 1, wherein the toner is a polymerized toner.

8. The image forming apparatus as claimed in claim 1, wherein the toner image is formed on the surface of the image bearing body after uniformly charging the surface of the image bearing body with a charging member to which a voltage is applied; and wherein the charging member comes into contact with the image bearing body.

9. The image forming apparatus as claimed in claim 1, wherein the toner image is formed on the surface of the image bearing body after uniformly charging the surface of the image bearing body with a charging member to which a voltage is applied; and wherein the charging member opposes the image bearing body with a minute gap.

10. The image forming apparatus as claimed in claim 8, wherein the voltage in which alternating current is superposed onto direct current is applied.

11. A process cartridge which can be attached to and detached from the image forming apparatus as claimed in claim 1, wherein at least one of the cleaning apparatus and a developing unit which includes the image bearing body and which forms the toner image is integrally formed therewith.
